(19) United States
(12) Patent Application Publication
(10) Pub. No.: US 2009/0262845 A1
(43) Pub. Date: Oct. 22, 2009

(54) Method for transmitting and receiving data using pilot structure

(76) Inventors: Sung Ho Park, Anyang-si (KR); Jin Young Chun, Anyang-si (KR); Jin Soo Choi, Anyang-si (KR); Hyun Soo Ko, Anyangi-si (KR); Bin Chul Imh, Anyang-si (KR); Wook Bong Lee, Anyang-si (KR)

Correspondence Address: MCKENNA LONG & ALDRIDGE LLP, 1900 K STREET, NW, WASHINGTON, DC, 20006, US

(21) Appl. No.: 12/385,456

(22) Filed: Apr. 8, 2009

Related U.S. Application Data
(60) Provisional application No. 61/045,280, filed on Apr. 16, 2008.
(60) Provisional application No. 61/074,155, filed on Jun. 20, 2008.

(30) Foreign Application Priority Data
Oct. 13, 2008 (KR) 10-2008-0099978
Oct. 16, 2008 (KR) 10-2008-0101650

(51) Int. Cl. H04L 27/28

(52) U.S. Cl. 375/260

(57) ABSTRACT

A method for efficiently transmitting and receiving data in a wireless access system and a pilot allocation structure for the same are provided. In the method, data is transmitted using a resource block constructed taking into consideration channel estimation capabilities and data transfer rate and data is received using the resource block. The resource block includes a predetermined number of pilot symbols constructed in a predetermined pattern and the pilot symbols are allocated to the resource block at a predetermined allocation rate taking into consideration the number of transmit antennas.

### CROSS REFERENCE TO RELATED APPLICATIONS

This application claims the benefit of the U.S. provisional Application Nos. 61/045,280 and 61/074,155 filed on Apr. 16, 2008 and Jun. 20, 2008, respectively, which are hereby incorporated by reference as if fully set forth herein

This application claims the benefit of the Korean Patent Application Nos. 10-2008-0099978 and 10-2008-0101650 filed on Oct. 13, 2008 and Oct. 16, 2008, which are hereby incorporated by reference as if fully set forth herein.

### TECHNICAL FIELD

The present invention relates to a method for efficiently transmitting and receiving data in a wireless access system and a pilot allocation structure for efficient data transmission.

### BACKGROUND ART

The following is a brief description of a channel estimation method and pilot signals.

To detect a synchronous signal, a receiver should have information regarding wireless channels such as attenuation, phase shift, or time delay. Here, the term “channel estimation” refers to estimation of the reference phase and the size of each carrier. Wireless channel environments have fading characteristics such that the condition of a channel irregularly changes in the time and frequency domains as time passes. Channel estimation serves to estimate the amplitude and phase of such a channel. Namely, channel estimation serves to estimate a frequency response of a wireless link or a wireless channel.

In one channel estimation method, a reference value is estimated based on pilot symbols of several base stations using a two-dimensional channel estimator. Here, the term “pilot symbols” refers to symbols that do not contain actual data but instead have high power to support carrier phase synchronization and acquisition of base station information. The transmitting and receiving ends can perform channel estimation using such pilot symbols. Specifically, the transmitting and receiving ends estimate a channel using pilot symbols known to both the transmitting and receiving ends and reconstruct data using the estimated value.

FIG. 1 illustrates an example of a general pilot structure used in a single-transmit-antenna structure.

The pilot structure of FIG. 1 is applied when one transmit antenna is used. When one antenna is used, two pilot subcarriers are used for each even symbol and two pilot subcarriers are used for each odd symbol. In this case, an overhead of about 14.28% may occur due to pilot subcarriers.

FIG. 2 illustrates an example of a general pilot structure used in a two-transmit-antenna structure.

In downlink, Space-Time Coding (STC) is used to provide high-order transmit diversity. Here, two or more transmit antennas are needed to support STC.

As shown in FIG. 2, two transmit antennas (first and second antennas) can simultaneously transmit different data symbols. Here, data symbols are repeatedly transmitted in the time domain (space-time) and the frequency domain (space-frequency). Accordingly, the pilot structure of FIG. 2 can exhibit higher capabilities when transmitting data although receiver complexity is increased.

The method of allocating data in the example of FIG. 2 can be changed in order to use two antennas having the same channel estimation capabilities. A respective pilot symbol is transmitted twice through each antenna. The position of the pilot symbol is changed over four symbol durations. Symbols are counted starting from the beginning of the current region, and the first symbol number is even.

In the example of FIG. 2, pilot subcarriers are used for channel estimation. Here, an overhead of about 14.28% may occur due to pilot subcarriers.

FIG. 3 illustrates an example of a general pilot structure used in a four-transmit-antenna structure.

When four antennas (first, second, third, and fourth antennas) are used, transmit diversity can be improved, compared to when two antennas are used. Even when four antennas are used, the pilot structure of FIG. 3 can exhibit the same channel estimation capabilities as when two transmit antennas are used.

As shown in FIG. 3, respective pilot channels of the antennas are allocated to each symbol. For example, when one symbol includes 14 subchannels, respective pilots of the four antennas are allocated to subcarriers of each symbol. Thus, an overhead of about 28.57% may occur due to pilot subcarriers.

As described above, an overhead of about 14.28% may occur due to pilot subcarriers when one transmit antenna is used and when two transmit antennas are used. In addition, an overhead of about 28.57% may occur due to pilot subcarriers when four transmit antennas are used.

### DISCLOSURE

### Technical Problem

Permutation methods that are generally used include Partial Usage of Subchannel (PUSC), Full Usage of Subchannel (FUSC), and Adaptive Modulation and Coding (AMC). The permutation methods may use different pilot subcarrier allocation structures.

This is because different optimal structures can be defined for the permutation methods since the permutation methods are separated in time. A unified basic data allocation structure is required when the permutation methods are present together in time.

It can be seen from FIGS. 1 to 3 that significant overhead occurs due to pilot subcarriers in the conventional Orthogonal Frequency Division Multiplexing (OFDM) system. Such pilot overhead may reduce link throughput, thereby causing a reduction in system capabilities. The conventional pilot structures have a problem in that they do not maintain commonality between a plurality of antennas in a multiple-antenna system. Thus, conventional pilot structures have a problem in that transfer rate is reduced when pilot overhead is significant.

An object of the present invention devised to solve the problems lies on providing a method for efficiently transmitting data.

Another object of the present invention devised to solve the problem lies on providing a pilot subcarrier allocation structure that can be applied to a system having multiple transmit antennas in order to increase data transfer rate.

A further object of the present invention devised to solve the problem lies on providing a data allocation structure unified for a variety of permutation methods.

### Technical Solution

To achieve the objects of the present invention, the present invention provides a method for efficiently transmitting data in a wireless access system. The present invention also provides a pilot allocation structure for efficient data transmission.

In one aspect of the present invention, provided herein is a method for transmitting and receiving data in a wireless access system, the method including transmitting data using a resource block constructed taking into consideration channel estimation capabilities and data transfer rate, and receiving data using the resource block. Here, the resource block may include a predetermined number of pilot symbols constructed in a predetermined pattern and the pilot symbols may be allocated to the resource block at a predetermined allocation rate taking into consideration the number of transmit antennas.

A structure of subcarriers and OFDM symbols of the resource block may be one of a 9? structure, a 9? structure, and a 9? structure. The structure of subcarriers and OFDM symbols of the resource block may also be one of an 18? structure, an 18? structure, an 18? structure, and a 4? structure.

The pilot symbols may be allocated at intervals of 2 OFDM symbols or at intervals of 3 OFDM symbols taking into consideration a coherent time of a moving speed of a terminal. Here, the pilot symbols may be allocated at intervals of 8 subcarriers or at intervals of 9 subcarriers taking into consideration frequency-selective characteristics.

When the number of transmit antennas is 1, the predetermined allocation rate of the pilot symbols may be in a range of substantially 11.11% to substantially 16.67%. When the number of transmit antennas is 2, the predetermined allocation rate of the pilot symbols may be in a range of substantially 11.11% to substantially 22.22%.

The same number of pilot symbols may be allocated to each OFDM symbol included in the resource block. Here, for boosting power of the pilot symbols, power may be borrowed from at least one data symbol included in each OFDM symbol to which the pilot symbols are allocated. Examples of the method for borrowing power from the data symbol include stealing or puncturing.

The wireless access system may support, as a multiple-antenna transmission scheme, at least one of Spatial Frequency Block Coding (SFBC), Spatial Time Block Coding (STBC), and Spatial Multiplexing (SM). Here, when the wireless access system supports SFBC, the pilot symbols may be located adjacent to each other in a frequency domain, and, when the wireless access system supports STBC, the pilot symbols may be located adjacent to each other in a time domain.

When the pilot symbols include pilot symbols of two or more antennas, pilot symbols for a first antenna and a second antenna among the two or more antennas may be multiplexed using different codes.

When a first user and a second user perform collaborative transmission, the pilot symbols may be multiplexed using different codes for the first and second users.

When a first user and a second user perform collaborative transmission, the pilot symbols may be multiplexed using different antenna indices for the first and second users.

When transmit antennas of a first user and transmit antennas of a second user each include a first antenna and a second antenna, the first and second antennas may be discriminated through different pilot allocation structures and the first and second users may be discriminated using different codes.

### Advantageous Effects

The embodiments of the present invention have the following advantages.

First, if the pilot allocation structures described in the embodiments of the present invention are used, it is possible to efficiently transmit and receive data.

Second, if the pilot allocation structures described in the embodiments of the present invention are used, it is possible to use a unified data allocation structure for a variety of permutation methods.

Third, if the pilot allocation structures described in the embodiments of the present invention are used, systems which use the same permutation mode at the same time can use a unified pilot allocation structure without using different pilot allocation schemes according to resource allocation methods.

Fourth, the embodiments of the present invention can efficiently reduce pilot subcarrier overhead, thereby increasing data transfer rate.

Fifth, the spirit of the present invention can be applied to any system that uses multiple transmit/receive antennas.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates an example of a general pilot structure used in a single-transmit-antenna structure.

FIG. 2 illustrates an example of a general pilot structure used in a two-transmit-antenna structure.

FIG. 3 illustrates an example of a general pilot structure used in a four-transmit-antenna structure.

FIG. 4 illustrates pilot allocation structures according to a first embodiment of the present invention.

FIG. 5 illustrates pilot allocation structures according to the first embodiment of the present invention.

FIG. 6 illustrates pilot allocation structures according to the first embodiment of the present invention.

FIG. 7 illustrates pilot allocation structures according to the first embodiment of the present invention.

FIG. 8 illustrates pilot allocation structures according to the first embodiment of the present invention.

FIG. 9 illustrates pilot allocation structures according to the first embodiment of the present invention.

FIG. 10 illustrates pilot allocation structures according to the first embodiment of the present invention.

FIG. 11 illustrates pilot allocation structures according to the first embodiment of the present invention.

FIG. 12 illustrates an exemplary method for generating a new pilot allocation structure by cyclically shifting a pilot allocation structure according to the second embodiment of the present invention.

FIG. 13 illustrates another exemplary method for generating a new pilot allocation structure by cyclically shifting a pilot allocation structure according to the second embodiment of the present invention.

FIG. 14 illustrates another exemplary method for generating a new pilot allocation structure by cyclically shifting a pilot allocation structure according to the second embodiment of the present invention.

FIG. 15 illustrates another exemplary method for generating a new pilot allocation structure by cyclically shifting a pilot allocation structure according to the second embodiment of the present invention.

FIG. 16 illustrates another exemplary method for generating a new pilot allocation structure by cyclically shifting a pilot allocation structure according to the second embodiment of the present invention.

FIG. 17 illustrates another exemplary method for generating a new pilot allocation structure by cyclically shifting a pilot allocation structure according to the second embodiment of the present invention.

FIG. 18 illustrates another exemplary method for generating a new pilot allocation structure by cyclically shifting a pilot allocation structure according to the second embodiment of the present invention.

FIG. 19 illustrates another exemplary method for generating a new pilot allocation structure by cyclically shifting a pilot allocation structure according to the second embodiment of the present invention.

FIG. 20 illustrates another exemplary method for generating a new pilot allocation structure by cyclically shifting a pilot allocation structure according to the second embodiment of the present invention.

FIG. 21 illustrates an exemplary method for generating a new pilot allocation structure by cyclically shifting a pilot allocation structure according to a third embodiment of the present invention.

FIG. 22 illustrates another exemplary method for generating a new pilot allocation structure by cyclically shifting a pilot allocation structure according to the third embodiment of the present invention.

FIG. 23 illustrates another exemplary method for generating a new pilot allocation structure by cyclically shifting a pilot allocation structure according to the third embodiment of the present invention.

FIG. 24 illustrates another exemplary method for generating a new pilot allocation structure by cyclically shifting a pilot allocation structure according to the third embodiment of the present invention.

FIG. 25 illustrates a variety of pilot allocation structures according to the third embodiment of the present invention.

FIG. 26 illustrates a variety of pilot allocation structures according to the third embodiment of the present invention.

FIG. 27 illustrates a variety of pilot allocation structures according to the third embodiment of the present invention.

FIG. 28 illustrates a variety of pilot allocation structures according to the third embodiment of the present invention.

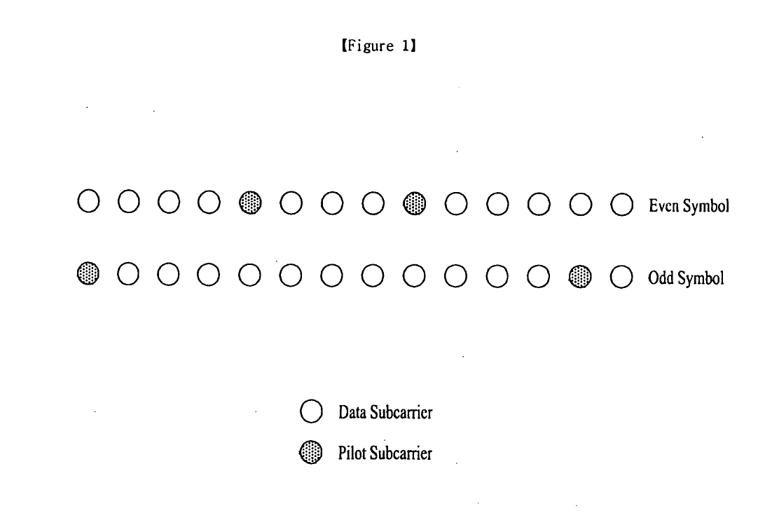

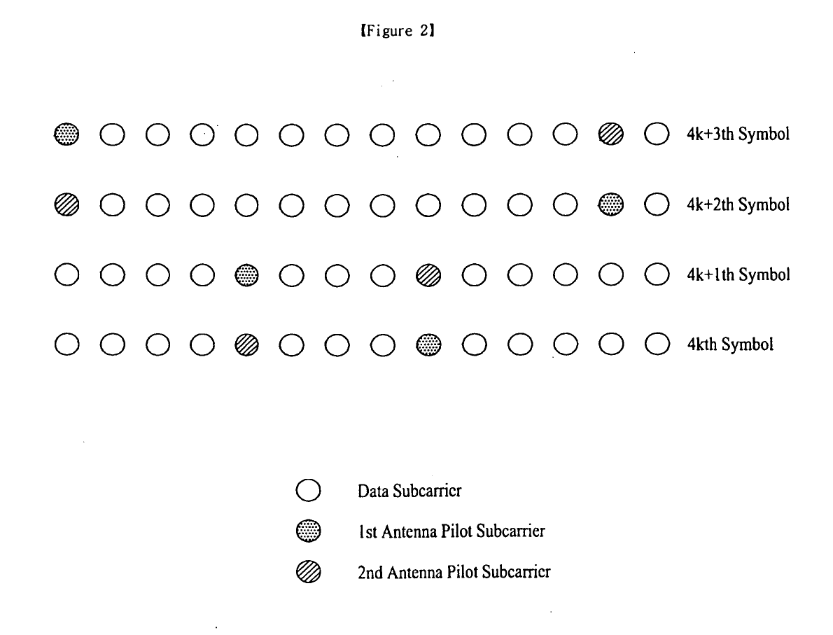

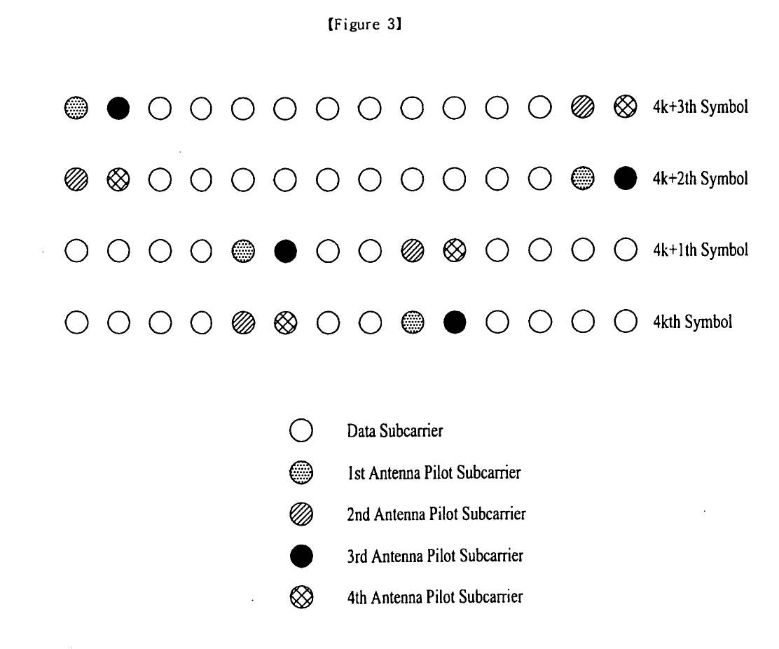

### BEST MODE

The embodiments of the present invention provide a variety of methods for transmitting data using a pilot allocation structure in a wireless access system.

The embodiments described below are provided by combining components and features of the present invention in specific forms. The components or features of the present invention can be considered optional if not explicitly stated otherwise. The components or features may be implemented without being combined with other components or features. The embodiments of the present invention may also be provided by combining some of the components and/or features. The order of the operations described below in the embodiments of the present invention may be changed. Some components or features of one embodiment may be included in another embodiment or may be replaced with corresponding components or features of another embodiment.

In the following description made in conjunction with the drawings, procedures or steps that may obscure the subject matter of the present invention are not described and procedures or steps that will be apparent to those skilled in the art are also not described.

The embodiments of the present invention have been described focusing mainly on the data communication relationship between a terminal and a Base Station (BS). The BS is a terminal node in a network which performs communication directly with the terminal. Specific operations which have been described as being performed by the BS may also be performed by an upper node as needed.

That is, it will be apparent to those skilled in the art that the BS or any other network node may perform various operations for communication with terminals in a network including a number of network nodes including BSs. Here, the term “base station (BS)” may be replaced with another term such as “fixed station”, “Node B”, “eNode B (eNB)”, or “access point”. The terminal conceptually includes a Mobile Station (MS) and a stationary station. The term “terminal” may also be replaced with another term such as “User Equipment (UE)”, “Subscriber Station (SS)”, “Mobile Subscriber Station (MSS)”, or “mobile terminal”. The term “stationary terminal” may also be replaced with another term such as “notebook” or “laptop”.

The term “transmitting end” refers to a node that transmits data or audio services and “receiving end” refers to a node that receives data or audio services. Thus, in uplink, the terminal may be a transmitting end and the base station may be a receiving end. Similarly, the terminal may be a receiving end and the base station may be a transmitting end.

A Personal Digital Assistant (PDA), a cellular phone, a Personal Communication Service (PCS) phone, a Global System for Mobile (GSM) phone, a Wideband CDMA (WCDMA) phone, or a Mobile Broadband System (MBS) phone may be used as the mobile terminal in the present invention.

The methods according to the embodiments of the present invention can be implemented by hardware, firmware, software, or any combination thereof.

In the case where the present invention is implemented by hardware, an embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

*79In the case where the present invention is implemented by firmware or software, the methods according to the embodiments of the present invention may be implemented in the form of modules, processes, functions, or the like which perform the features or operations described below. Software code can be stored in a memory unit so as to be executed by a processor. The memory unit may be located inside or outside the processor and can communicate data with the processor through a variety of known means.

The embodiments of the present invention can be supported by standard documents of at least one of the IEEE 802 system, the 3GPP system, the 3GPP LTE system, and the 3GPP2 system which are wireless access systems. That is, steps or portions that are not described in the embodiments of the present invention for the sake of clearly describing the spirit of the present invention can be supported by the standard documents. For all terms used in this disclosure, reference can be made to the standard documents. Especially, the embodiments of the present invention can be supported by P802.16e-2005 or P802.16Rev2/D4 (April 2008), which are standard documents of the IEEE 802.16 system.

Specific terms used in the following description are provided for better understanding of the present invention and can be replaced with other terms without departing from the spirit of the present invention.

Pilot allocation structures described in the embodiments of the present invention can be designed taking into consideration a variety of factors. The pilot allocation structures described in the embodiments of the present invention can be repeatedly applied in the time domain and the frequency domain in a frame or a subframe.

For example, the pilot allocation structures can be designed taking into consideration the intervals between pilot symbols in the time and frequency domains, the ratio of the amount of data transmission to pilot density, and the rate of power per symbol in consideration of power boosting. In the case where multiple antennas are used, it is possible to additionally take into consideration the ratio of power per symbol between antennas in consideration of power boosting and whether or not it is possible to efficiently support multiple-antenna transmission schemes.

The following is a detailed description of important factors that are taken into consideration when a pilot allocation structure is designed.

1. Pilot Symbol Allocation Interval

It is preferable that the interval between pilot symbols in pilot allocation structures according to the spirit of the present invention be maintained to be equal to or less than 2 or 3 symbols, taking into consideration a coherent time of the moving speed of the terminal (for example, 120Km/h). It is also preferable that the interval between pilot symbols be maintained to be equal to or less than 8 or 9 subcarriers as an effective coherence bandwidth, taking into consideration frequency-selective characteristics. However, these requirements can be adjusted according to trade-off between channel estimation capabilities of pilots and data transfer rate.

2. Pilot Allocation Rate According to the Number of Transmit Antennas

In the embodiments of the present invention, the pilot allocation rate can be changed according to the number of transmit antennas. For example, it is preferable that pilots be allocated at a rate of about 11.11%-16.67% in a Resource Block (RB) when one transmit antenna is used and it is preferable that pilots be allocated at a rate of about 11.11%-22.22% in a Resource Block (RB) when two transmit antennas are used.

The term “Resource Block (RB)” used in the embodiments of the present invention refers to a set of Resource Elements (REs) which includes m subcarriers and n OFDM symbols. Here, the term “RE” may refer to a resource allocation unit including one subcarrier and one OFDM symbol. The terms “RB” and “RE” have been defined to appropriately express the spirit of the present invention and can be used to describe any resource allocation units that perform the same functions.

3. Power Boosting

In order to improve channel estimation capabilities of terminals, it is possible to take into consideration power boosting. For example, in order to boost pilot symbols, it is possible to take into consideration clipping or back-off based on boosted pilot power. In the case where clipping or back-off is taken into consideration, power loss due to clipping or back-off may cause a reduction in the capabilities of the terminal.

In order to boost pilot symbol power, it is possible to borrow data power through stealing or puncturing. In this case, the channel estimation capabilities can be improved. However, when the channel condition is poor, data processing capability may be reduced due to power loss of the data region. It is possible to select a most appropriate method from among the power boosting methods, taking into consideration a variety of factors such as channel environments or overall capabilities in various ways. If data symbol power is borrowed when pilot symbol power is boosted, this may not cause a power difference between OFDM symbols.

However, if only the pilot symbol power is boosted without borrowing the data symbol power, this may cause a power difference between transmitted OFDM symbols. In this case, the available maximum power of a Power Amplifier (PA) is set based on the boosted pilot power. Thus, there may be problems in that it is necessary to use an expensive PA with a relatively wide power range and the power efficiency of the PA is reduced.

Accordingly, in order to avoid non-uniform power of OFDM symbols, it is preferable that power of the data region be borrowed through stealing or puncturing or that each OFDM symbols have the same number of pilots to make the power level of each symbol equal.

The embodiments of the present invention provide pilot allocation structures not only for a single transmit antenna but also for multiple transmit antennas. The pilot allocation structure for multiple transmit antennas may cause a difference between power levels of transmit antennas per OFDM symbol. Accordingly, in order to reduce the power difference between antennas, it is preferable that each OFDM symbol be designed so as to have pilot symbols of all antennas.

4. Multiple Antenna Transmission Scheme

Pilot allocation structures described in the embodiments of the present invention need to be able to efficiently support multiple-antenna transmission schemes. For example, when it is assumed that two or more transmit antennas are present, it is generally possible to take into consideration Spatial Frequency Block Coding (SFBC), Spatial Time Block Coding (STBC), Spatial Multiplexing (SM), and the like.

When channel estimation capabilities are taken into consideration, in the case of SFBC, a channel between two subcarriers coded for two antennas should be flat and, in the case of STBC, the flatter the channel between two coded symbols is, the greater the increase in data transmission capability. Accordingly, in the case where the communication system supports SFBC, it is preferable that pilots of two antennas be located adjacent to each other in the frequency domain. In addition, in the case where the communication system supports STBC, it is preferable that pilots of two antennas be located adjacent to each other in the time domain.

The embodiments of the present invention provide pilot allocation schemes according to the number of transmit antennas. Here, in a pilot allocation scheme of multiple transmit antennas, it is possible to apply a different pilot allocation structure to each antenna.

Pilot allocation structures illustrated in the present invention are basically designed taking into consideration both the case where a single transmit antenna is used and the case where two transmit antennas are used. However, in the case where four transmit antennas are used, it is possible to attach a specific code to a pilot allocation structure used for a pair of transmit antennas to discriminate it from that of the other pair of antennas. That is, even when a pilot structure for two transmit antenna is used, it is possible to support a pilot allocation structure for four transmit antennas. In addition, when it is assumed that collaborative Spatial Multiplexing (SM) or collaborative transmission is employed, it is possible to discriminate between respective pilot allocation structures of users using a specific code for each user.

Each pilot allocation structure described in the embodiments of the present invention can be applied to both uplink and downlink. The pilot allocation structure may be used for common pilots only and may also be used for dedicated pilots only. The pilot allocation structure may also be used for both the common and dedicated pilots.

A signal such as a control channel or a preamble can be carried in the pilot structure described in the embodiments of the present invention. Here, a pilot may not be carried only at positions of the pilot structure to which the control channel or preamble is allocated. In addition, a dedicated pilot may be allocated only at positions of the pilot structure to which the control channel or preamble is allocated. The embodiments of the present invention may also be applied to a pilot allocation structure for Multicast and Broadcast Service (MBS) data transmission.

Each pilot allocation structure used in the embodiments of the present invention described below can be represented on an RB basis. Here, the vertical axis of the pilot allocation structure may represent a subcarrier index “m” as the frequency domain and the horizontal axis may represent an OFDM symbol index “n” as the time domain. The embodiments of the present invention can support a multiple-antenna system. Here, an RE to which a pilot symbol of the first transmit antenna is allocated is denoted by “1” and an RE to which a pilot symbol of the second transmit antenna is allocated is denoted by “2”. Unnoted REs are those for data transmission.

In the embodiments of the present invention, in the case where terminals, each having one transmit antenna, perform collaborative Spatial Multiplexing (SM) or collaborative transmission, it is possible to discriminate between the terminals using different antenna indices or alternatively using both different antenna indices and corresponding codes.

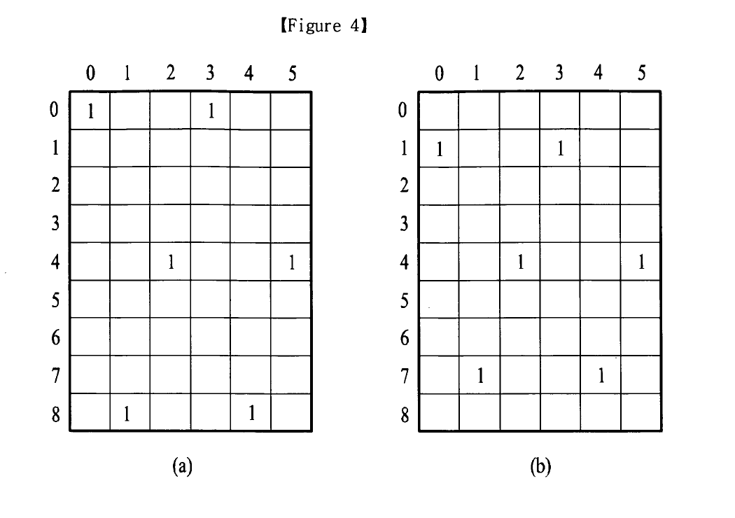

FIG. 4 illustrates pilot allocation structures according to a first embodiment of the present invention.

Specifically, FIG. 4 illustrates pilot allocation structures in the case where the number of transmit antennas is 1, each RB has a 9×6 structure, and the rate of pilot symbol allocation in an RB is about 11.11%.

As shown in FIG. 4, pilot symbols are allocated at intervals (or spacings) of 9 subcarriers on the same frequency axis and at intervals of 3 OFDM symbols on the same time axis. In the pilot allocation structure of FIG. 4(a), a pilot symbol is allocated to each OFDM symbol, alternately at positions having subcarrier indices m of 0, 4, and 8. In the pilot allocation structure of FIG. 4(b), a pilot symbol is allocated to each OFDM symbol, alternately at positions having subcarrier indices m of 1, 4, and 7.

The pilot allocation structures of FIG. 4 may be used in a 9×3 structure. For example, each pilot allocation structure may be divided into units at intervals of 9 subcarriers and 3 OFDM symbols and each unit may be used as an independent pilot symbol structure. In the pilot allocation structures of FIGS. 4(a) and 4(b), pilots are allocated such that the pilot pattern having the 9×3 structure is repeated twice.

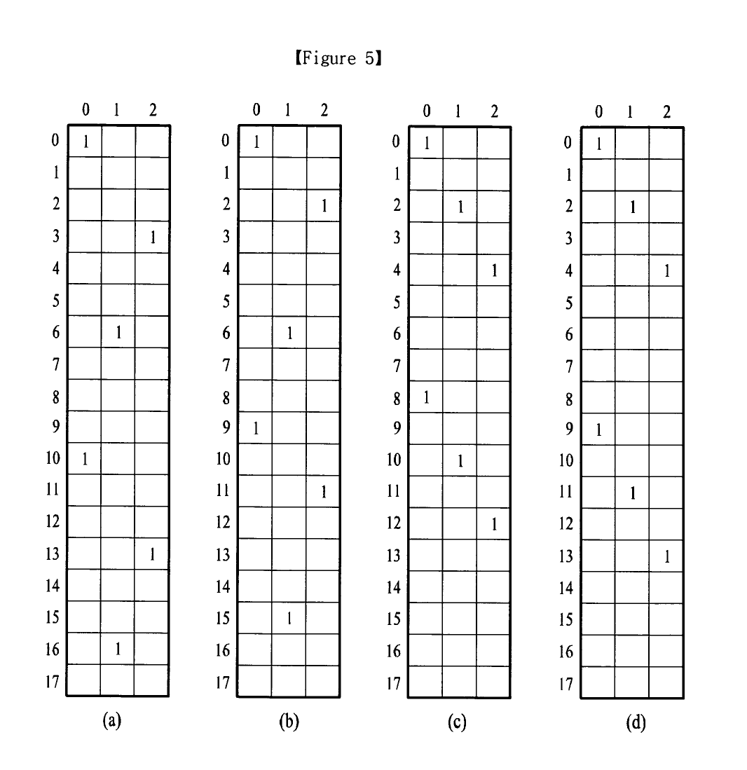

FIG. 5 illustrates pilot allocation structures according to the first embodiment of the present invention.

Specifically, FIG. 5 illustrates pilot allocation structures in the case where the number of transmit antennas is 1, each RB has an 18×3 structure, and the rate of pilot symbol allocation in an RB is about 11.11%.

As shown in FIG. 5(a), pilot symbols are repeatedly allocated at intervals of 18 subcarriers on the same frequency axis and at intervals of 3 OFDM symbols on the same time axis. In the pilot allocation structure of FIG. 5(a), two pilot symbols are allocated to each OFDM symbol such that two pilot symbols are allocated to the first OFDM symbol at positions having subcarrier indices m of 0 and 10, two pilot symbols are allocated to the second OFDM symbol at positions having subcarrier indices m of 6 and 16, and two pilot symbols are allocated to the third OFDM symbol at positions having subcarrier indices m of 3 and 13.

As shown in FIG. 5(b), pilot symbols are repeatedly allocated at intervals of 9 subcarriers on the same frequency axis and at intervals of 3 OFDM symbols on the same time axis. In the pilot allocation structure of FIG. 5B, two pilot symbols are allocated to each OFDM symbol such that two pilot symbols are allocated to the first OFDM symbol at positions having subcarrier indices m of 0 and 9, two pilot symbols are allocated to the second OFDM symbol at positions having subcarrier indices m of 6 and 15, and two pilot symbols are allocated to the third OFDM symbol at positions having subcarrier indices m of 2 and 11.

The pilot allocation structures of FIG. 5(b) may be used in a 9×3 structure. For example, each pilot allocation structure may be divided into units at intervals of 9 subcarriers and 3 OFDM symbols and each unit may be used as an independent pilot allocation structure. In the cases of FIG. 5(b), pilots are allocated such that the pilot pattern having the 9×3 structure is repeated twice.

As shown in FIG. 5(c), pilot symbols are repeatedly allocated at intervals of 18 subcarriers on the same frequency axis and at intervals of 3 OFDM symbols on the same time axis. In the pilot allocation structure of FIG. 5(c), two pilot symbols are allocated to each OFDM symbol such that two pilot symbols are allocated to the first OFDM symbol at positions having subcarrier indices m of 0 and 8, two pilot symbols are allocated to the second OFDM symbol at positions having subcarrier indices m of 2 and 10, and two pilot symbols are allocated to the third OFDM symbol at positions having subcarrier indices m of 4 and 12.

As shown in FIG. 5(d), pilot symbols are repeatedly allocated at intervals of 9 subcarriers on the same frequency axis and at intervals of 3 OFDM symbols on the same time axis. In the pilot allocation structure of FIG. 5(d), two pilot symbols are allocated to each OFDM symbol such that two pilot symbols are allocated to the first OFDM symbol at positions having subcarrier indices m of 0 and 9, two pilot symbols are allocated to the second OFDM symbol at positions having subcarrier indices m of 2 and 11, and two pilot symbols are allocated to the third OFDM symbol at positions having subcarrier indices m of 4 and 13.

The pilot allocation structures of FIG. 5(d) may be used in a 9×3 structure. For example, each pilot allocation structure may be divided into units at intervals of 9 subcarriers and 3 OFDM symbols and each unit may be used as an independent pilot allocation structure. In the cases of FIG. 5(d), pilots are allocated such that the pilot pattern having the 9×3 structure is repeated twice.

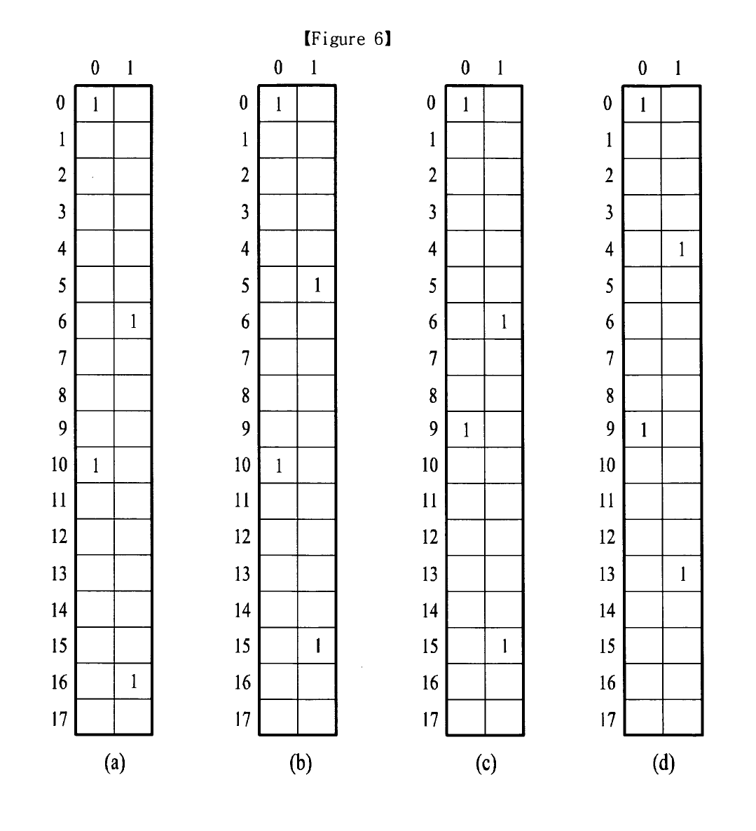

FIG. 6 illustrates pilot allocation structures according to the first embodiment of the present invention.

Specifically, FIG. 6 illustrates pilot allocation structures in the case where the number of transmit antennas is 1, each RB has an 18×2 structure, and the rate of pilot symbol allocation in an RB is about 16.67%.

In the pilot allocation structures of FIGS. 6(a) and 6(b), pilot symbols are allocated at intervals of 18 subcarriers and 2 OFDM symbols. In the pilot allocation structures of FIGS. 6(c) and 6(d), pilot symbols are also allocated at intervals of 18 subcarriers and 2 OFDM symbols.

Specifically, in the pilot allocation structure of FIG. 6(a), two pilot symbols are allocated to the first OFDM symbol at positions having subcarrier indices m of 0 and 10 and two pilot symbols are allocated to the second OFDM symbol at positions having subcarrier indices m of 6 and 16. In the pilot allocation structure of FIG. 6(b), two pilot symbols are allocated to the first OFDM symbol at positions having subcarrier indices m of 0 and 10 and two pilot symbols are allocated to the second OFDM symbol at positions having subcarrier indices m of 5 and 15.

In the pilot allocation structure of FIG. 6(c), two pilot symbols are allocated to the first OFDM symbol (n=0) at positions having subcarrier indices m of 0 and 9 and two pilot symbols are allocated to the second OFDM symbol (n=1) at positions having subcarrier indices m of 6 and 15. In the pilot allocation structure of FIG. 6(d), two pilot symbols are allocated to the first OFDM symbol (n=0) at positions having subcarrier indices m of 0 and 9 and two pilot symbols are allocated to the second OFDM symbol (n=1) at positions having subcarrier indices m of 4 and 13.

The pilot allocation structures of FIGS. 6(c) and 6(d) may be used in a 9×2 structure. For example, each pilot allocation structure may be divided into units at intervals of 9 subcarriers and 2 OFDM symbols and each unit may be used as an independent pilot allocation structure. In the pilot allocation structures of FIGS. 6(c) and 6(d), pilots are allocated such that the pilot pattern having the 9×2 structure is repeated twice.

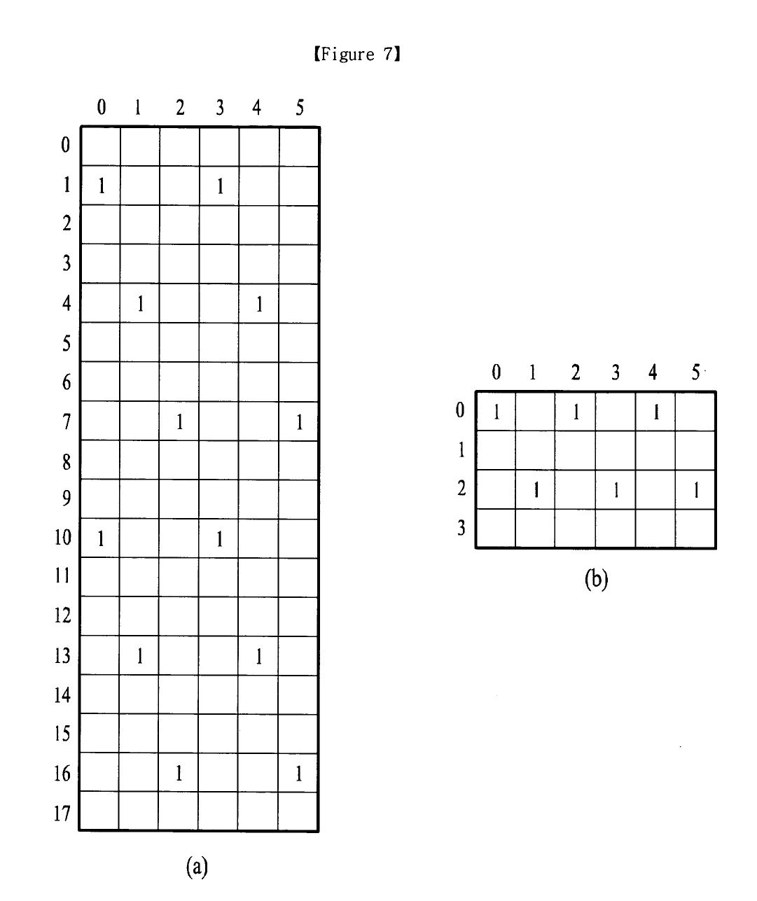

FIG. 7 illustrates pilot allocation structures according to the first embodiment of the present invention.

Specifically, FIG. 7(a) illustrates a pilot allocation structure in the case where each RB has an 18×6 structure and the rate of pilot symbol allocation in an RB is about 11.11%. In the pilot allocation structure of FIG. 7(a), pilot symbols are repeatedly allocated at intervals of 9 subcarriers on the frequency axis and at intervals of 3 OFDM symbols on the time axis.

More specifically, in the pilot allocation structure of FIG. 7(a), two pilot symbols are allocated to the first OFDM symbol (n=0) at positions having subcarrier indices m of 1 and 10, two pilot symbols are allocated to the second OFDM symbol (n=1) at positions having subcarrier indices m of 4 and 13, and two pilot symbols are allocated to the third OFDM symbol (n=2) at positions having subcarrier indices m of 7 and 16. In the remaining fourth to sixth OFDM symbols, pilot symbols are allocated in the same pattern as in the first to third OFDM symbols.

The pilot allocation structures of FIG. 7(a) may be used in a 9×3 structure. For example, each pilot allocation structure may be divided into units at intervals of 9 subcarriers and 3 OFDM symbols and each unit may be used as an independent pilot symbol structure. In the cases of FIG. 7(a), pilots are allocated such that the pilot pattern having the 9×3 structure is repeated four times.

FIG. 7(b) illustrates a pilot allocation structure in the case where each RB has a 4×6 structure and the rate of pilot symbol allocation in an RB is about 25%. In the pilot allocation structure of FIG. 7(b), pilot symbols are repeatedly allocated at intervals of 4 subcarriers on the frequency axis and at intervals of 2 OFDM symbols on the time axis.

More specifically, in the pilot allocation structure of FIG. 7(b), a pilot symbol is allocated to the first OFDM symbol (n=0) at a position having a subcarrier index m of 0 and a pilot symbol is allocated to the second OFDM symbol (n=1) at a position having a subcarrier index m of 2. In the remaining third to sixth OFDM symbols, pilot symbols are allocated in the same pattern as in the first and second OFDM symbols.

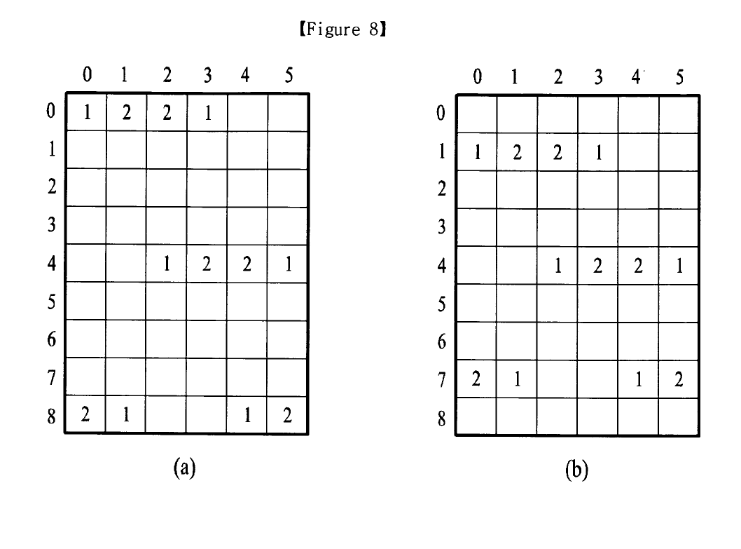

FIG. 8 illustrates pilot allocation structures according to the first embodiment of the present invention.

Specifically, FIG. 8 illustrates pilot allocation structures in the case where the number of transmit antennas is 2, each RB has a 9×6 structure, and the rate of pilot symbol allocation in an RB is about 22.22%. In the pilot allocation structures of FIG. 8, respective pilot symbols of the two transmit antennas can be allocated to each OFDM symbol.

In the pilot allocation structure of FIG. 8(a), in the first OFDM symbol (n=0), a pilot symbol of the first transmit antenna (Tx #1) is allocated to a position having a subcarrier index m of 0 and a pilot symbol of the second transmit antenna (Tx #2) is allocated to a position having a subcarrier index m of 8. In the second OFDM symbol (n=1), a pilot symbol of the second transmit antenna (Tx #2) is allocated to a position having a subcarrier index m of 0 and a pilot symbol of the first transmit antenna (Tx #1) is allocated to a position having a subcarrier index m of 8.

In the third OFDM symbol (n=2), a pilot symbol of Tx #2 is allocated to a position having a subcarrier index m of 0 and a pilot symbol of Tx #1 is allocated to a position having a subcarrier index m of 4. In the fourth OFDM symbol (n=3), a pilot symbol of Tx #1 is allocated to a position having a subcarrier index m of 0 and a pilot symbol of Tx #2 is allocated to a position having a subcarrier index m of 4.

In the fifth OFDM symbol (n=4), a pilot symbol of Tx #2 is allocated to a position having a subcarrier index m of 4 and a pilot symbol of Tx #1 is allocated to a position having a subcarrier index m of 8. In the sixth OFDM symbol (n=5), a pilot symbol of Tx #1 is allocated to a position having a subcarrier index m of 4 and a pilot symbol of Tx #2 is allocated to a position having a subcarrier index m of 8.

The pilot allocation structure of FIG. 8(b) is similar to that of FIG. 8(a). Specifically, the pilot allocation structure of FIG. 8(b) is generated by shifting, by one subcarrier, pilot symbols allocated to the subcarriers of m=0 and 8 at both ends of the RB in the pilot allocation structure of FIG. 8(a) such that the shifted pilot symbols are allocated to the subcarriers of m=1 and 7. The pilot allocation structure of FIG. 8(b) is designed to reduce interference and collision between pilot symbols that may occur on the frequency axis when the pilot allocation structure is repeatedly allocated on the time axis and the frequency axis.

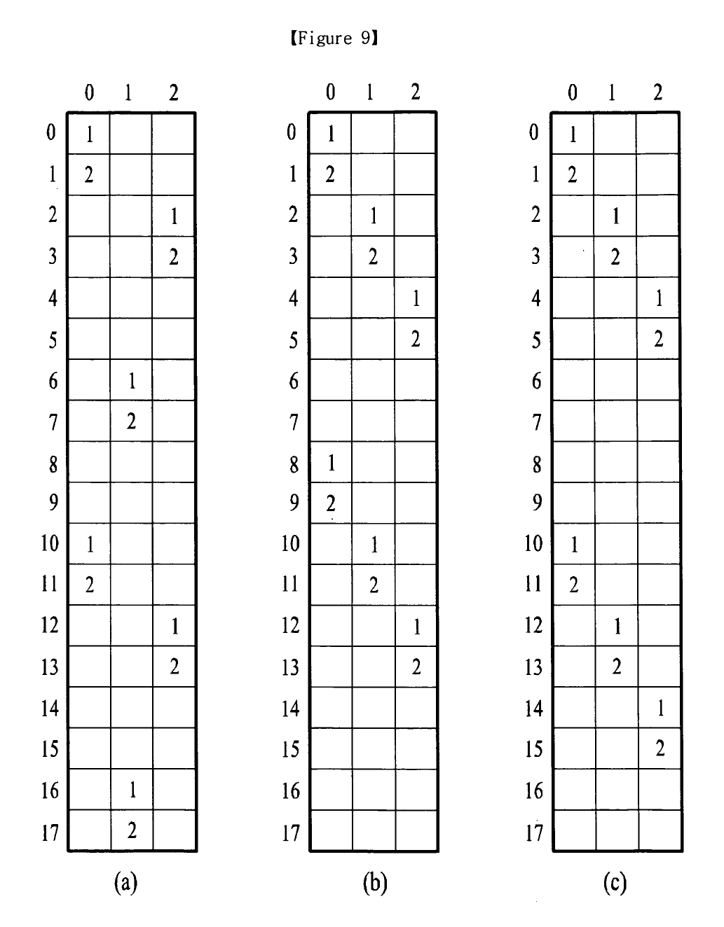

FIG. 9 illustrates pilot allocation structures according to the first embodiment of the present invention.

Specifically, FIG. 9 illustrates pilot allocation structures in the case where the number of transmit antennas is 2, each RB has an 18×3 structure, and the rate of pilot symbol allocation in an RB is about 22.22%. In the pilot allocation structures of FIG. 9, respective pilot symbols of the two transmit antennas can be repeatedly allocated to each OFDM symbol.

In the pilot allocation structure of FIG. 9(a), in the first OFDM symbol (n=0), pilot symbols of the first transmit antenna (Tx #1) can be allocated to positions having subcarrier indices m of 0 and 10 and pilot symbols of the second transmit antenna (Tx #2) can be allocated to positions having subcarrier indices m of 1 and 11. In the second OFDM symbol (n=1), pilot symbols of Tx #1 can be allocated to positions having subcarrier indices m of 6 and 16 and pilot symbols of Tx #2 can be allocated to positions having subcarrier indices m of 7 and 17. In the third OFDM symbol (n=2), pilot symbols of Tx #1 can be allocated to positions having subcarrier indices m of 2 and 12 and pilot symbols of Tx #2 can be allocated to positions having subcarrier indices m of 3 and 13.

In the pilot allocation structure of FIG. 9(b), in the first OFDM symbol (n=0), pilot symbols of Tx #1 can be allocated to positions having subcarrier indices m of 0 and 8 and pilot symbols of Tx #2 can be allocated to positions having subcarrier indices m of 1 and 9. In the second OFDM symbol (n=1), pilot symbols of Tx #1 can be allocated to positions having subcarrier indices m of 2 and 10 and pilot symbols of Tx #2 can be allocated to positions having subcarrier indices m of 3 and 11. In the third OFDM symbol (n=2), pilot symbols of Tx #1 can be allocated to positions having subcarrier indices m of 4 and 12 and pilot symbols of Tx #2 can be allocated to positions having subcarrier indices m of 5 and 13.

In the pilot allocation structure of FIG. 9(c), in the first OFDM symbol (n=0), pilot symbols of Tx #1 can be allocated to positions having subcarrier indices m of 0 and 10 and pilot symbols of Tx #2 can be allocated to positions having subcarrier indices m of 1 and 11. In the second OFDM symbol (n=1), pilot symbols of Tx #1 can be allocated to positions having subcarrier indices m of 2 and 12 and pilot symbols of Tx #2 can be allocated to positions having subcarrier indices m of 3 and 13. In the third OFDM symbol (n=2), pilot symbols of Tx #1 can be allocated to positions having subcarrier indices m of 4 and 14 and pilot symbols of Tx #2 can be allocated to positions having subcarrier indices m of 5 and 15.

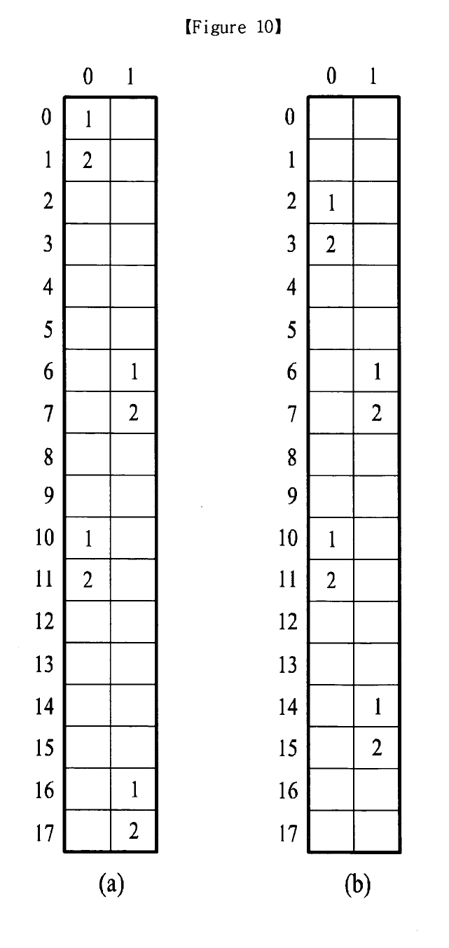

FIG. 10 illustrates pilot allocation structures according to the first embodiment of the present invention.

Specifically, FIG. 10 illustrates pilot allocation structures in the case where the number of transmit antennas is 2, each RB has an 18×2 structure, and the rate of pilot symbol allocation in an RB is about 22.22%. In the pilot allocation structures of FIG. 10, respective pilot symbols of the two transmit antennas can be repeatedly allocated to each OFDM symbol.

In the pilot allocation structure of FIG. 10(a), in the first OFDM symbol (n=0), pilot symbols of the first transmit antenna (Tx #1) can be allocated to positions having subcarrier indices m of 0 and 10 and pilot symbols of the second transmit antenna (Tx #2) can be allocated to positions having subcarrier indices m of 1 and 11. In the second OFDM symbol (n=1), pilot symbols of Tx #1 can be allocated to positions having subcarrier indices m of 6 and 16 and pilot symbols of Tx #2 can be allocated to positions having subcarrier indices m of 7 and 17.

In the pilot allocation structure of FIG. 10(b), in the first OFDM symbol (n=0), pilot symbols of Tx #1 can be allocated to positions having subcarrier indices m of 2 and 10 and pilot symbols of Tx #2 can be allocated to positions having subcarrier indices m of 3 and 11. In the second OFDM symbol (n=1), pilot symbols of Tx #1 can be allocated to positions having subcarrier indices m of 6 and 14 and pilot symbols of Tx #2 can be allocated to positions having subcarrier indices m of 7 and 15.

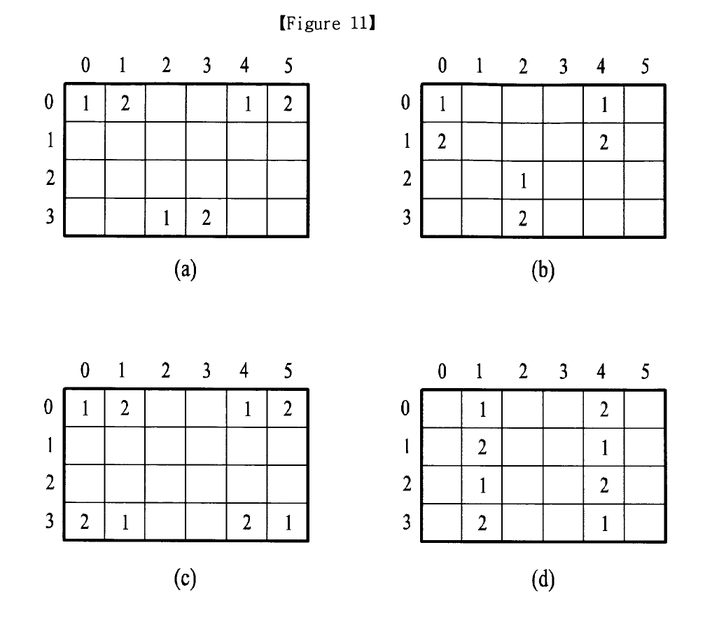

FIG. 11 illustrates pilot allocation structures according to the first embodiment of the present invention.

Specifically, FIG. 11 illustrates pilot allocation structures in the case where the number of transmit antennas is 2, each RB has a 4×6 structure, and the rate of pilot symbol allocation in an RB is about 25%.

In the pilot allocation structure of FIG. 11(a), one pilot symbol is allocated to each OFDM symbol. In the pilot allocation structures of FIGS. 11(b), 11(c), and 11(d), pilot symbols are allocated only to specific OFDM symbols.

In the pilot allocation structure of FIG. 11(a), a pilot symbol of the first transmit antenna (Tx #1) is allocated to a Resource Element (RE) having a subcarrier index m of 0 in the first OFDM symbol (n=0) and a pilot symbol of the first transmit antenna (Tx #2) is allocated to an RE having a subcarrier index m of 0 in the second OFDM symbol (n=1). In addition, a pilot symbol of Tx #1 is allocated to an RE having a subcarrier index m of 3 in the third OFDM symbol (n=2) and a pilot symbol of Tx #2 is allocated to an RE having a subcarrier index m of 3 in the fourth OFDM symbol (n=3). The pilot allocation positions of the fifth and sixth OFDM symbols are equal to those of the first and second OFDM symbols.

In the pilot allocation structure of FIG. 11(b), pilot symbols are allocated to OFDM symbols having OFDM symbol indices n of 0, 2, and 4. Specifically, in OFDM symbols of n=0 and 4, pilot symbols of Tx #1 are allocated respectively to REs of m=0 and pilot symbols of Tx #2 are allocated respectively to REs of m=1. In addition, in an OFDM symbol of n=2, a pilot symbol of Tx #1 is allocated to an RE of m=2 and a pilot symbol of Tx #2 is allocated to an RE of m=3.

In the pilot allocation structure of FIG. 11(c), pilot symbols are allocated to OFDM symbols having OFDM symbol indices n of 0, 1, 4, and 5. Specifically, in OFDM symbols of n=0 and 4, pilot symbols of Tx #1 are allocated respectively to REs of m=0 and pilot symbols of Tx #2 are allocated respectively to REs of m=3. In addition, in OFDM symbols of n=1 and 5, pilot symbols of Tx #2 are allocated respectively to REs of m=0 and pilot symbols of Tx #1 are allocated respectively to REs of m=3.

In the pilot allocation structure of FIG. 11(d), pilot symbols are allocated to OFDM symbols having OFDM symbol indices n of 1 and 4. Specifically, in an OFDM symbol of n=1, pilot symbols of Tx #1 are allocated respectively to REs of m=0 and 2 and pilot symbols of Tx #2 are allocated respectively to REs of m=1 and 3. In addition, in an OFDM symbol of n=4, pilot symbols of Tx #2 are allocated respectively to REs of m=0 and 2 and pilot symbols of Tx #1 are allocated respectively to REs of m=1 and 3.

The following is a description of exemplary methods for cyclically shifting a pilot allocation structure according to a second embodiment of the present invention.

When the same pilot allocation structure is used in all cells, each pilot is allocated at the same position in each cell or each antenna. In this case, interference may occur between pilot symbols of different cells or different antennas. In addition, if pilot power boosting is used in order to improve channel estimation capabilities, this may accelerate the reduction of capabilities due to such interference effects or pilot position collision.

It is preferable that pilot patterns that do not overlap be used for different cells in order to overcome this problem. However, it is more preferable that pilot patterns which do not overlap without departing from conventional pilot structures be used for different cells.

Accordingly, the second embodiment of the present invention provides a method for allocating pilots by cyclically shifting pilots allocated according to a conventional pilot allocation scheme in each cell and pilot allocation structures generated using the method. When a specific pilot allocation structure is determined, it is possible to use a pilot allocation structure generated by cyclically shifting the specific pilot allocation structure in the time or frequency domain in each cell. Users can use each of the new pilot allocation structures generated by cyclically shifting the specific pilot allocation structure as an individual pilot allocation structure. That is, pilot patterns generated through cyclic shift can each be used as an individual pattern in each cell or base station.

It is possible to use all or part of the pilot patterns in the pilot allocation structures generated through cyclic shift according to the second embodiment of the present invention. Here, each base station may previously define a pilot pattern for use.

Although the indices of pilot patterns described in the embodiments of the present invention may each be arbitrarily mapped to a pilot symbol allocation method for use with the pilot pattern, the same pilot pattern is not mapped to different pilot symbol allocation methods. However, in some cases, base stations may use the same pilot pattern.

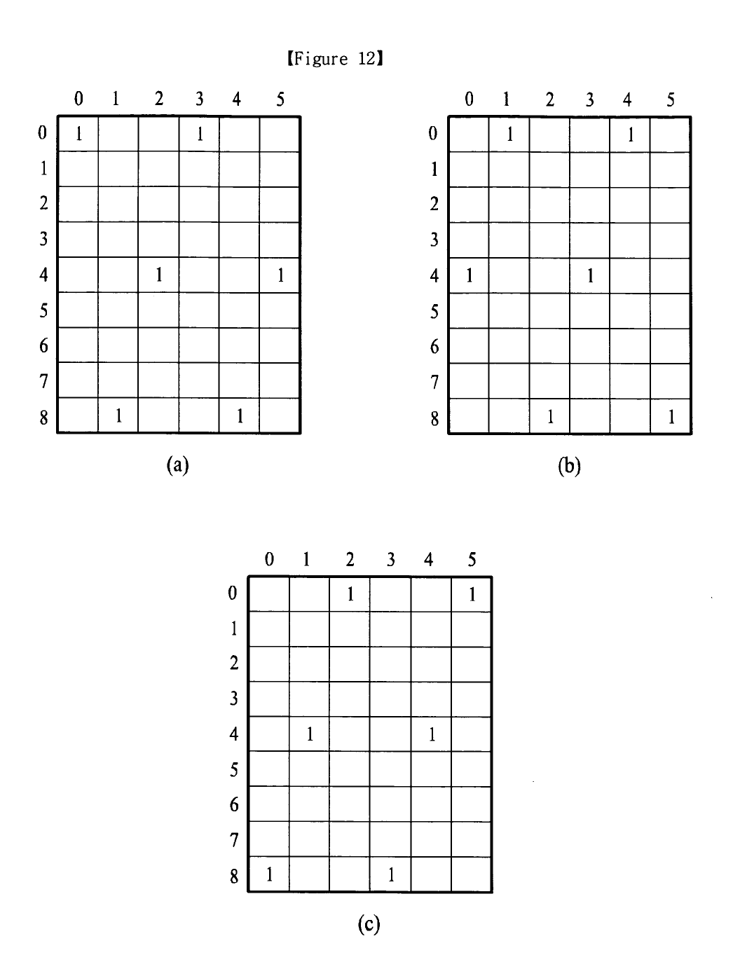

FIG. 12 illustrates an exemplary method for generating a new pilot allocation structure by cyclically shifting a pilot allocation structure according to the second embodiment of the present invention.

Specifically, FIG. 12 illustrates pilot allocation structures in the case where the number of transmit antennas is 1, each RB has a 9×6 structure, and the rate of pilot symbol allocation in an RB is about 11.11%.

In the pilot allocation structure of FIG. 12(a), a pilot symbol is allocated to each OFDM symbol. More specifically, in the pilot allocation structure of FIG. 12(a), a pilot symbol is allocated to a Resource Element (RE) having a subcarrier index m of 0 in the first OFDM symbol (n=0), a pilot symbol is allocated to an RE having a subcarrier index m of 8 in the second OFDM symbol (n=1), and a pilot symbol is allocated to an RE having a subcarrier index m of 4 in the third OFDM symbol (n=2). The pilot structure of the first to third OFDM symbols is repeated in the remaining fourth to sixth OFDM symbols.

FIG. 12(b) illustrates a pilot allocation structure generated by cyclically shifting the pilot allocation structure of FIG. 12(a) to the right side by one OFDM symbol and FIG. 12(c) illustrates a pilot allocation structure generated by cyclically shifting the pilot allocation structure of FIG. 12(b) to the right side by one OFDM symbol.

The pilot allocation structures of FIGS. 12(a) to 12(c) may be used in a 9×3 structure. For example, each pilot allocation structure may be divided into units at intervals of 9 subcarriers and 3 OFDM symbols and each unit may be used as an independent pilot allocation structure. In the pilot allocation structures of FIGS. 12(a) to 12(c), pilots are allocated such that the pilot pattern having the 9×3 structure is repeated twice.

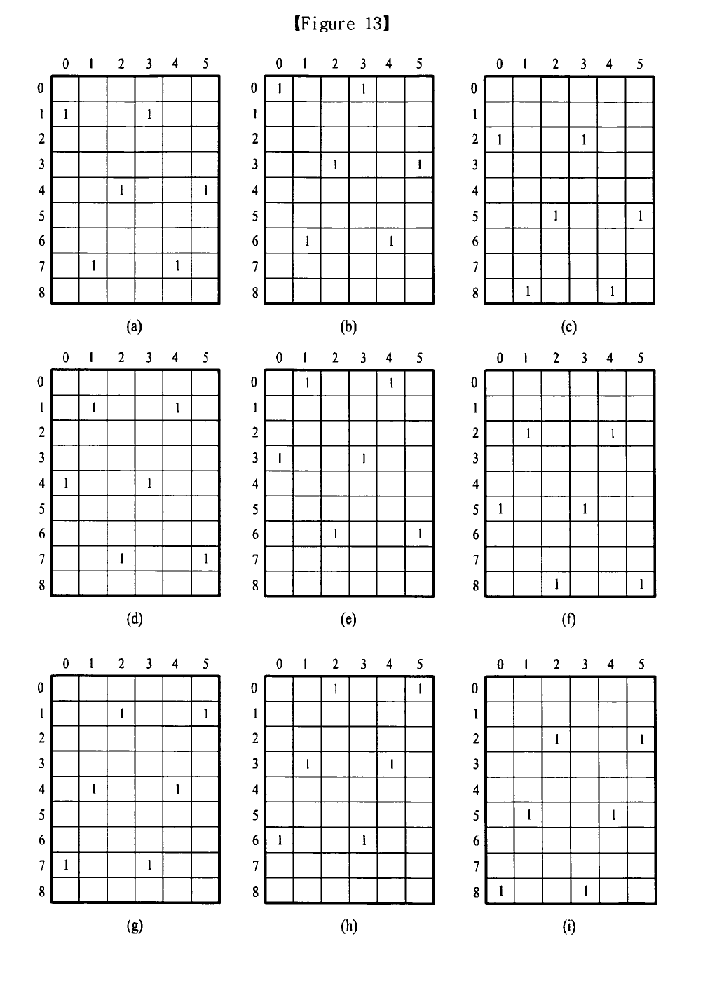

FIG. 13 illustrates another exemplary method for generating a new pilot allocation structure by cyclically shifting a pilot allocation structure according to the second embodiment of the present invention.

Specifically, FIG. 13 illustrates pilot allocation structures in the case where the number of transmit antennas is 1, each RB has a 9×6 structure, and the rate of pilot symbol allocation in an RB is about 11.11%.

In the pilot allocation structure of FIG. 13(a), a pilot symbol is allocated to each OFDM symbol. More specifically, in the pilot allocation structure of FIG. 13(a), a pilot symbol is allocated to a Resource Element (RE) having a subcarrier index m of 1 in the first OFDM symbol (n=0), a pilot symbol is allocated to an RE having a subcarrier index m of 7 in the second OFDM symbol (n=1), and a pilot symbol is allocated to an RE having a subcarrier index m of 4 in the third OFDM symbol (n=2). The pilot structure of the first to third OFDM symbols is repeated in the remaining fourth to sixth OFDM symbols.

FIG. 13(b) illustrates a pilot allocation structure generated by cyclically shifting the pilot allocation structure of FIG. 13(a) to the upper side by one subcarrier. FIG. 13(c) illustrates a pilot allocation structure generated by cyclically shifting the pilot allocation structure of FIG. 13(a) to the lower side by one subcarrier. FIG. 13(d) illustrates a pilot allocation structure generated by cyclically shifting the pilot allocation structure of FIG. 13(a) to the right side by one OFDM symbol.

FIG. 13(e) illustrates a pilot allocation structure generated by cyclically shifting the pilot allocation structure of FIG. 13(a) to the right side by one OFDM symbol and cyclically shifting the pilot allocation structure to the upper side by one subcarrier. FIG. 13(f) illustrates a pilot allocation structure generated by cyclically shifting the pilot allocation structure of FIG. 13(a) to the right side by one OFDM symbol and cyclically shifting the pilot allocation structure to the lower side by one subcarrier.

FIG. 13(g) illustrates a pilot allocation structure generated by cyclically shifting the pilot allocation structure of FIG. 13(a) to the right side by two OFDM symbols and FIG. 13(h) illustrates a pilot allocation structure generated by cyclically shifting the pilot allocation structure of FIG. 13G to the upper side by one subcarrier. FIG. 13(i) illustrates a pilot allocation structure generated by cyclically shifting the pilot allocation structure of FIG. 13(g) to the lower side by one subcarrier.

The pilot allocation structures of FIGS. 13(a) to 13(i) may be used in a 9×3 structure. For example, each pilot allocation structure may be divided into units at intervals of 9 subcarriers and 3 OFDM symbols and each unit may be used as an independent pilot allocation structure. In the pilot allocation structures of FIGS. 13(a) to 13(i), pilots are allocated such that the pilot pattern having the 9×3 structure is repeated twice.

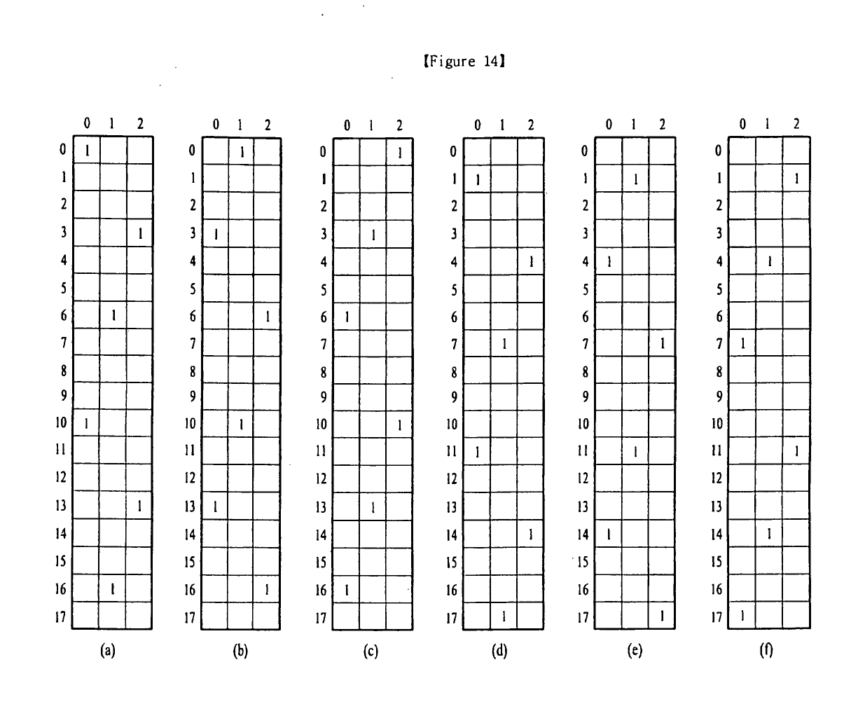

FIG. 14 illustrates another exemplary method for generating a new pilot allocation structure by cyclically shifting a pilot allocation structure according to the second embodiment of the present invention.

Specifically, FIG. 14 illustrates pilot allocation structures in the case where the number of transmit antennas is 1, each RB has an 18×3 structure, and the rate of pilot symbol allocation in an RB is about 11.11%. In the pilot allocation structures of FIG. 14, two pilot symbols are allocated to each OFDM symbol at intervals of 18 subcarriers and at intervals of 3 OFDM symbols.

In the pilot allocation structure of FIG. 14(a), pilot symbols are allocated respectively to Resource Elements (REs) having subcarrier indices m of 0 and 10 in the first OFDM symbol (n=0), pilot symbols are allocated to REs having subcarrier indices m of 6 and 16 in the second OFDM symbol (n=1), and pilot symbols are allocated to REs having subcarrier indices m of 3 and 13 in the third OFDM symbol (n=2).

FIG. 14(b) illustrates a pilot allocation structure generated by cyclically shifting the pilot allocation structure of FIG. 14(a) to the right side by one OFDM symbol and FIG. 14(c) illustrates a pilot allocation structure generated by cyclically shifting the pilot allocation structure of FIG. 14(b) to the right side by one OFDM symbol. FIG. 14(d) illustrates a pilot allocation structure generated by cyclically shifting the pilot allocation structure of FIG. 14(a) to the lower side by one subcarrier, FIG. 14(e) illustrates a pilot allocation structure generated by cyclically shifting the pilot allocation structure of FIG. 14(d) to the right side by one OFDM symbol, and FIG. 14(f) illustrates a pilot allocation structure generated by cyclically shifting the pilot allocation structure of FIG. 14(e) to the right side by one OFDM symbol.

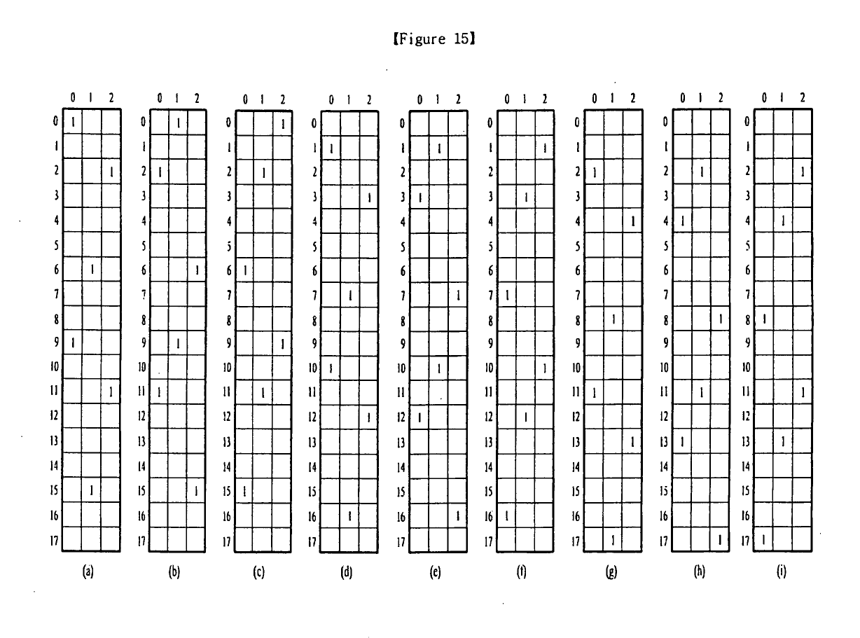

FIG. 15 illustrates another exemplary method for generating a new pilot allocation structure by cyclically shifting a pilot allocation structure according to the second embodiment of the present invention.

Specifically, FIG. 15 illustrates pilot allocation structures in the case where the number of transmit antennas is 1, each RB has an 18×3 structure, and the rate of pilot symbol allocation in an RB is about 11.11%. In the pilot allocation structures of FIG. 15, two pilot symbols are allocated to each OFDM symbol at intervals of 9 subcarriers and at intervals of 3 OFDM symbols.

In the pilot allocation structure of FIG. 15(a), pilot symbols are allocated respectively to Resource Elements (REs) having subcarrier indices m of 0 and 9 in the first OFDM symbol (n=0), pilot symbols are allocated to REs having subcarrier indices m of 6 and 15 in the second OFDM symbol (n=1), and pilot symbols are allocated to REs having subcarrier indices m of 2 and 11 in the third OFDM symbol (n=2).

FIG. 15(b) illustrates a pilot allocation structure generated by cyclically shifting the pilot allocation structure of FIG. 15(a) to the right side by one OFDM symbol and FIG. 15(c) illustrates a pilot allocation structure generated by cyclically shifting the pilot allocation structure of FIG. 15(b) to the right side by one OFDM symbol.

FIG. 15(d) illustrates a pilot allocation structure generated by cyclically shifting the pilot allocation structure of FIG. 15(a) to the lower side by one subcarrier, FIG. 15(e) illustrates a pilot allocation structure generated by cyclically shifting the pilot allocation structure of FIG. 15(d) to the right side by one OFDM symbol, and FIG. 15(f) illustrates a pilot allocation structure generated by cyclically shifting the pilot allocation structure of FIG. 15(e) to the right side by one OFDM symbol.

FIG. 15(g) illustrates a pilot allocation structure generated by cyclically shifting the pilot allocation structure of FIG. 15(a) to the lower side by two subcarriers, FIG. 15(h) illustrates a pilot allocation structure generated by cyclically shifting the pilot allocation structure of FIG. 15(g) to the right side by one OFDM symbol, and FIG. 15(i) illustrates a pilot allocation structure generated by cyclically shifting the pilot allocation structure of FIG. 15(h) to the right side by one OFDM symbol.

The pilot allocation structures of FIGS. 15(a) to 15(i) may be used in a 9×3 structure. For example, each pilot allocation structure may be divided into units at intervals of 9 subcarriers and 3 OFDM symbols and each unit may be used as an independent pilot allocation structure. In the pilot allocation structures of FIGS. 15(a) to 15(i), pilots are allocated such that the pilot pattern having the 9×3 structure is repeated twice.

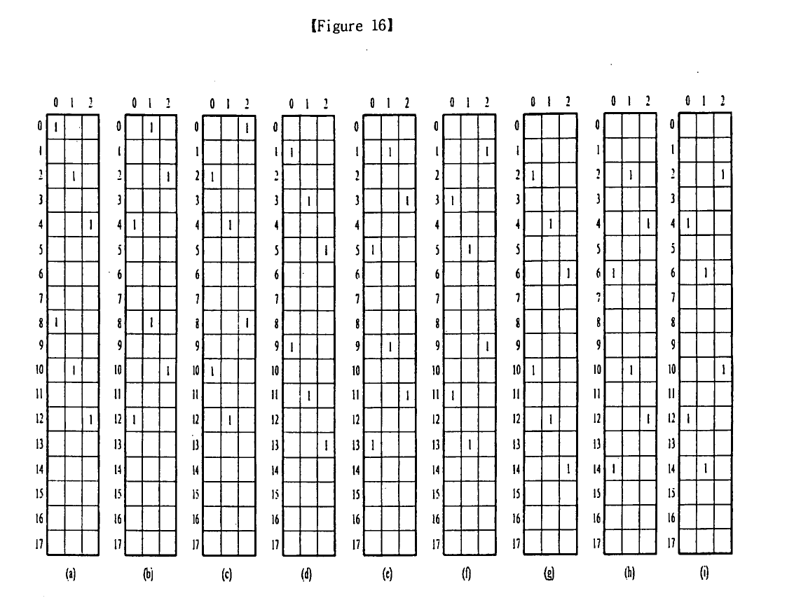

FIG. 16 illustrates another exemplary method for generating a new pilot allocation structure by cyclically shifting a pilot allocation structure according to the second embodiment of the present invention.

Specifically, FIG. 16 illustrates pilot allocation structures in the case where the number of transmit antennas is 1, each RB has an 18×3 structure, and the rate of pilot symbol allocation in an RB is about 11.11%. In the pilot allocation structures of FIG. 16, two pilot symbols are allocated to each OFDM symbol at intervals of 18 subcarriers and at intervals of 3 OFDM symbols. In the example of FIG. 16, the base station may allocate pilot symbols on an 18-subcarrier basis.

In the pilot allocation structure of FIG. 16(a), pilot symbols are allocated respectively to Resource Elements (REs) having subcarrier indices m of 0 and 8 in the first OFDM symbol (n=0), pilot symbols are allocated to REs having subcarrier indices m of 2 and 10 in the second OFDM symbol (n=1), and pilot symbols are allocated to REs having subcarrier indices m of 4 and 12 in the third OFDM symbol (n=2).

FIG. 16(b) illustrates a pilot allocation structure generated by cyclically shifting the pilot allocation structure of FIG. 16(a) to the right side by one OFDM symbol and FIG. 16(c) illustrates a pilot allocation structure generated by cyclically shifting the pilot allocation structure of FIG. 16(a) to the right side by two OFDM symbols.

FIG. 16(d) illustrates a pilot allocation structure generated by cyclically shifting the pilot symbols in the pilot allocation structure of FIG. 16(a) to the lower side by one subcarrier, FIG. 16(e) illustrates a pilot allocation structure generated by cyclically shifting the pilot symbols in the pilot allocation structure of FIG. 16(d) to the right side by one OFDM symbol, and FIG. 16(f) illustrates a pilot allocation structure generated by cyclically shifting the pilot symbols in the pilot allocation structure of FIG. 16(d) to the right side by two OFDM symbols.

In addition, FIG. 16(g) illustrates a pilot allocation structure generated by cyclically shifting the pilot symbols in the pilot allocation structure of FIG. 16(a) to the lower side by two subcarriers and FIGS. 16(h) and 16(i) illustrate two pilot allocation structures generated by cyclically shifting the pilot symbols in the pilot allocation structure of FIG. 16(g) to the right side sequentially on a 1 OFDM symbol basis.

The following is a description of other pilot allocation structures generated by modifying the pilot allocation structures of FIG. 16. Pilot allocation structures of such modifications have the same forms as those of FIGS. 16(a) to 16(c). Thus, how the pilot allocation structures of FIG. 16 are modified is described without corresponding drawings.

Specifically, other pilot allocation structures may be generated by cyclically shifting the pilot allocation structures of FIGS. 16A to 16C by 3 OFDM symbols, 4 OFDM symbols, or 5 OFDM symbols. Although these pilot allocation structures are not very meaningful in a structure with an RB size of 18×3, they may be meaningful in a structure with a size greater than the 18×3 structure.

Not all pilot allocation structures that can be generated by cyclically shifting the pilot allocation structure of FIG. 16(a) according to the embodiments of the present invention are illustrated in FIGS. 16(b) to 16(i). However, all pilot allocation structures that satisfy the spirit of the present invention can be obtained by cyclically shifting the allocation positions of the pilot symbols of the pilot allocation structure of FIG. 16(a) sequentially on an OFDM symbol-by-OFDM symbol basis or on a subcarrier-by-subcarrier basis.

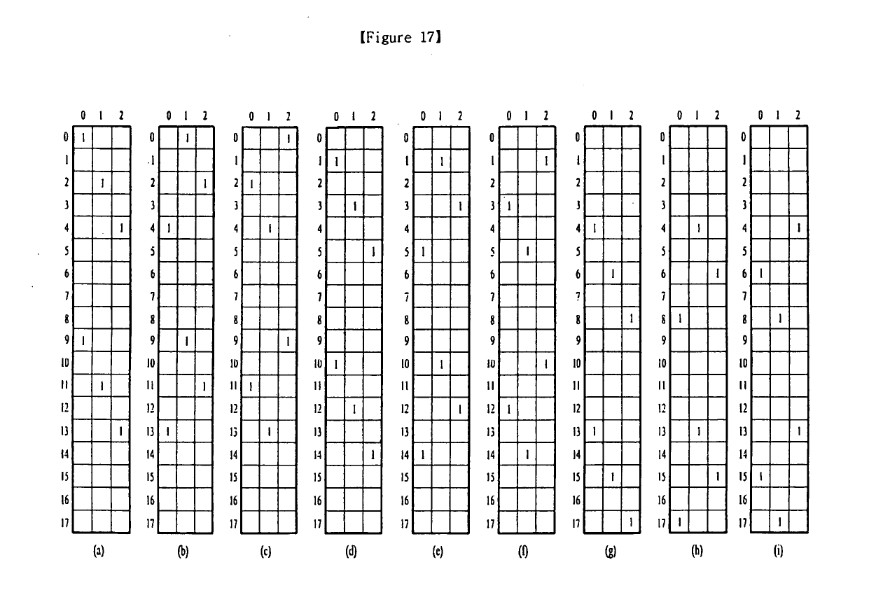

FIG. 17 illustrates another exemplary method for generating a new pilot allocation structure by cyclically shifting a pilot allocation structure according to the second embodiment of the present invention.

Specifically, FIG. 17 illustrates pilot allocation structures in the case where the number of transmit antennas is 1, each RB has an 18×3 structure, and the rate of pilot symbol allocation in an RB is about 11.11%. In the pilot allocation structures of FIG. 17, two pilot symbols are allocated to each OFDM symbol at intervals of 9 subcarriers and at intervals of 3 OFDM symbols. In the example of FIG. 17, the base station allocates pilot symbols on a 9-subcarrier basis.

In the pilot allocation structure of FIG. 17(a), pilot symbols are allocated respectively to Resource Elements (REs) having subcarrier indices m of 0 and 9 in the first OFDM symbol (n=0), pilot symbols are allocated to REs having subcarrier indices m of 2 and 11 in the second OFDM symbol (n=1), and pilot symbols are allocated to REs having subcarrier indices m of 4 and 13 in the third OFDM symbol (n=2).

FIG. 17(b) illustrates a pilot allocation structure generated by cyclically shifting the pilot allocation structure of FIG. 17(a) to the right side by one OFDM symbol and FIG. 17(c) illustrates a pilot allocation structure generated by cyclically shifting the pilot allocation structure of FIG. 17(a) to the right side by two OFDM symbols.

FIG. 17(d) illustrates a pilot allocation structure generated by cyclically shifting the pilot symbols in the pilot allocation structure of FIG. 17(a) to the lower side by one subcarrier, FIG. 17(e) illustrates a pilot allocation structure generated by cyclically shifting the pilot symbols in the pilot allocation structure of FIG. 17(d) to the right side by one OFDM symbol, and FIG. 17(f) illustrates a pilot allocation structure generated by cyclically shifting the pilot symbols in the pilot allocation structure of FIG. 17(d) to the right side by two OFDM symbols.

In addition, FIG. 17(g) illustrates a pilot allocation structure generated by cyclically shifting the pilot symbols in the pilot allocation structure of FIG. 17(a) to the lower side by four subcarriers and FIGS. 17(h) and 17(i) illustrate two pilot allocation structures generated by cyclically shifting the pilot symbols in the pilot allocation structure of FIG. 17(g) sequentially on a 1 OFDM symbol basis.

The following is a description of other pilot allocation structures generated by modifying the pilot allocation structures of FIG. 17. Pilot allocation structures of such modifications have the same forms as those of FIGS. 17(a) to 17(c). Thus, how the pilot allocation structures of FIG. 17 are modified is described without corresponding drawings.

Specifically, other pilot allocation structures may be generated by cyclically shifting the pilot allocation structures of FIG. 17 by 2 subcarriers or 3 subcarriers. Although these pilot allocation structures are not very meaningful in a structure with an RB size of 18×3, they may be meaningful in a structure with a size greater than the 18×3 structure.

Only some of the pilot allocation structures that can be generated by cyclically shifting the pilot allocation structure of FIG. 17(a) are illustrated in FIGS. 17(b) to 17(i). However, all pilot allocation structures that satisfy the spirit of the present invention can be obtained by cyclically shifting the allocation positions of the pilot symbols of the pilot allocation structure of FIG. 17(a) sequentially on an OFDM symbol-by-OFDM symbol basis or on a subcarrier-by-subcarrier basis.

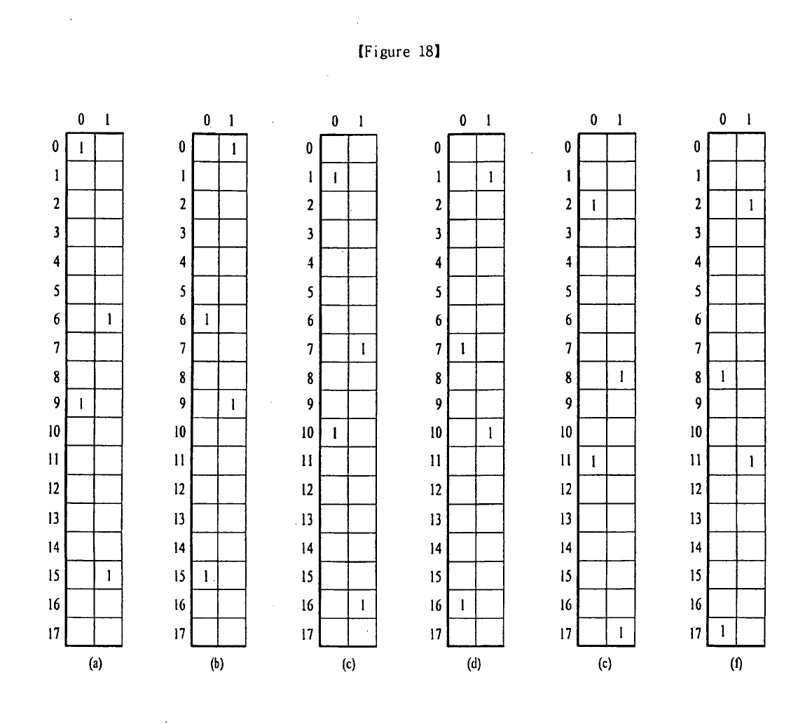

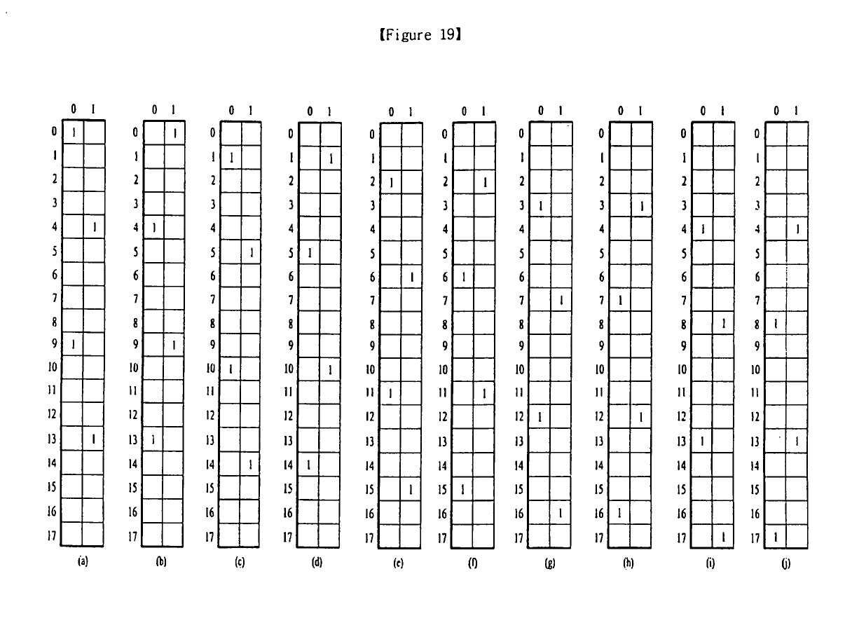

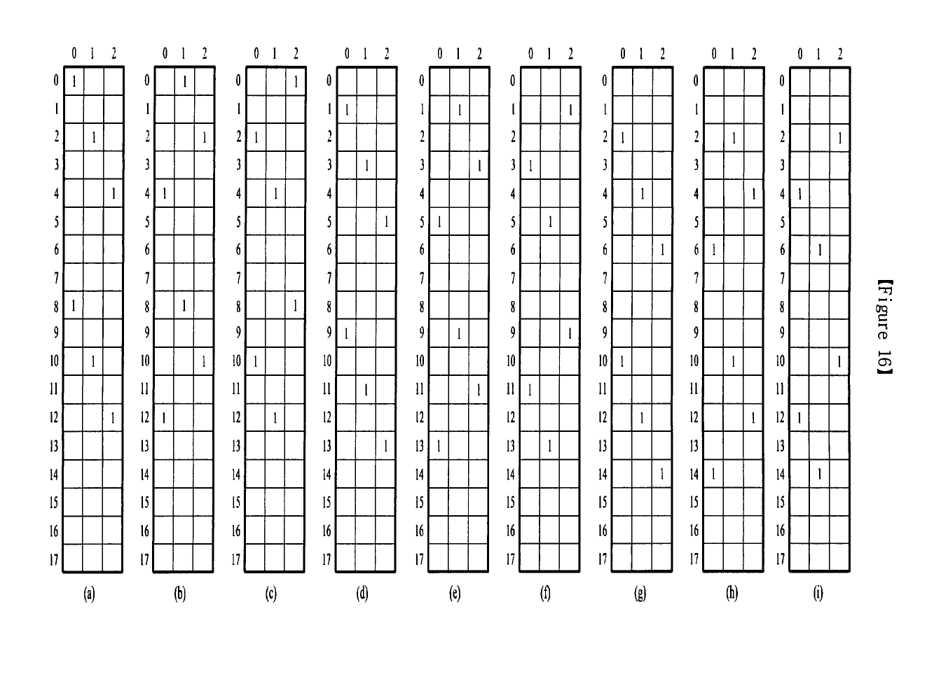

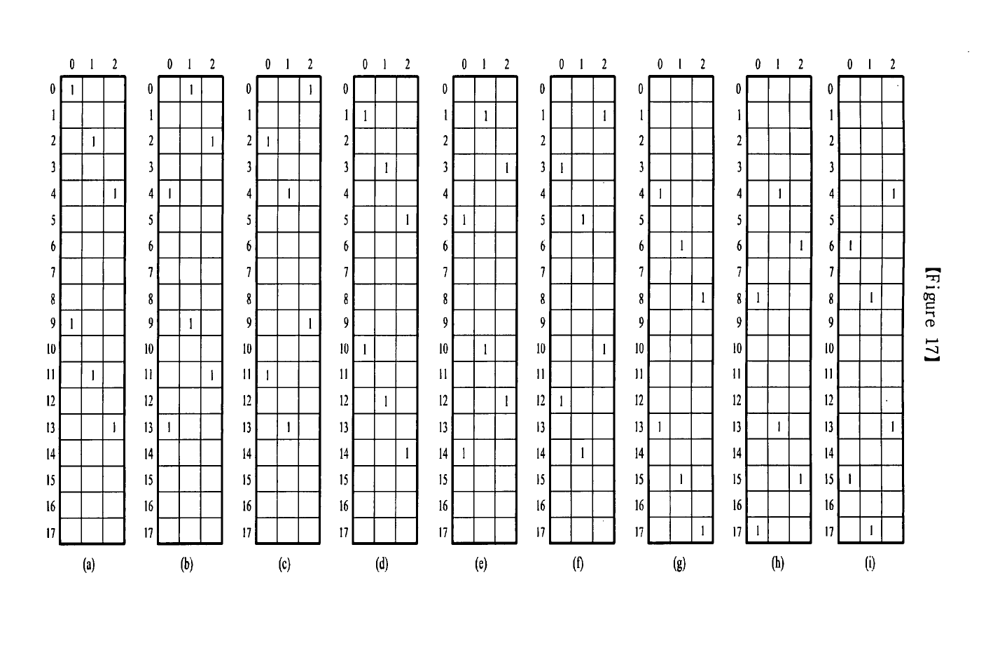

FIG. 18 illustrates another exemplary method for generating a new pilot allocation structure by cyclically shifting a pilot allocation structure according to the second embodiment of the present invention.

Specifically, FIG. 18 illustrates pilot allocation structures in the case where the number of transmit antennas is 1, each RB has an 18×2 structure, and the rate of pilot symbol allocation in an RB is about 11.11%. In the pilot allocation structures of FIG. 18, two pilot symbols are allocated to each OFDM symbol at intervals of 9 subcarriers and at intervals of 2 OFDM symbols. In the example of FIG. 18, the base station allocates pilot symbols on an 18-subcarrier basis.

In the pilot allocation structure of FIG. 18(a), pilot symbols are allocated respectively to Resource Elements (REs) having subcarrier indices m of 0 and 9 in the first OFDM symbol (n=0) and pilot symbols are allocated to REs having subcarrier indices m of 6 and 15 in the second OFDM symbol (n=1).

FIG. 18(b) illustrates a pilot allocation structure generated by cyclically shifting the pilot symbols in the pilot allocation structure of FIG. 18(a) by one OFDM symbol and FIG. 18(c) illustrates a pilot allocation structure generated by cyclically shifting the pilot symbols in the pilot allocation structure of FIG. 18(a) by one subcarrier. FIGS. 18(d) to 18(f) illustrate a method for cyclically shifting a pilot allocation structure sequentially on a 1 OFDM symbol basis and then cyclically shifting the structure on a 1 subcarrier basis.

Not all pilot allocation structures that can be generated by cyclically shifting the pilot allocation structure of the FIG. 18(a) are illustrated in FIGS. 18(b) to 18(f). However, all pilot allocation structures can be obtained by cyclically shifting the allocation positions of the pilot symbols of the pilot allocation structure of FIG. 18(a) sequentially on an OFDM symbol-by-OFDM symbol basis (which will also be referred to as a “1 OFDM symbol basis”) and cyclically shifting the allocation positions of the pilot symbols sequentially on a subcarrier-by-subcarrier basis (which will also be referred to as a “1 subcarrier basis”).

The pilot allocation structures of FIG. 18 may be used in a 9×2 structure. For example, each pilot allocation structure may be divided into units at intervals of 9 subcarriers and 2 OFDM symbols and each unit may be used as an independent pilot allocation structure. In the pilot allocation structures of FIG. 18, pilots are allocated such that the pilot pattern having the 9×2 structure is repeated twice.

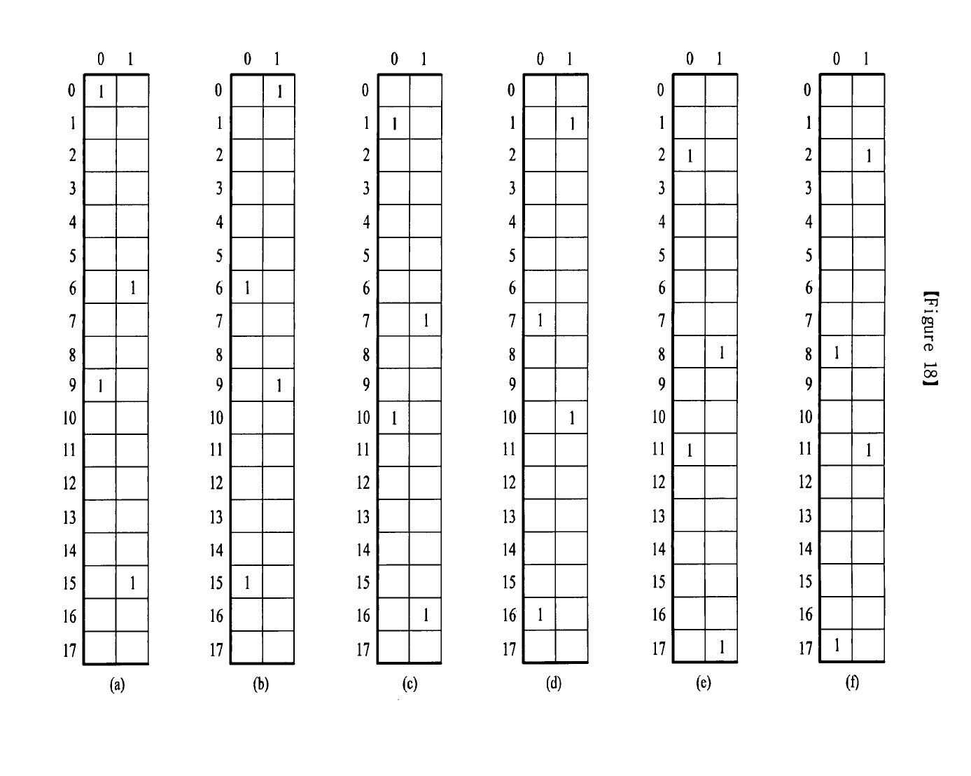

FIG. 19 illustrates another exemplary method for generating a new pilot allocation structure by cyclically shifting a pilot allocation structure according to the second embodiment of the present invention.

Specifically, FIG. 19 illustrates pilot allocation structures in the case where the number of transmit antennas is 1, each RB has an 18×2 structure, and the rate of pilot symbol allocation in an RB is about 11.11%. In the pilot allocation structures of FIGS. 19A to 19J, two pilot symbols are allocated to each OFDM symbol at intervals of 9 subcarriers and at intervals of 2 OFDM symbols. In the example of FIG. 19, the base station allocates pilot symbols on a 9-subcarrier basis.

In the pilot allocation structure of FIG. 19(a), pilot symbols are allocated respectively to Resource Elements (REs) having subcarrier indices m of 0 and 9 in the first OFDM symbol and pilot symbols are allocated to REs having subcarrier indices m of 4 and 13 in the second OFDM symbol.

FIG. 19(b) illustrates a pilot allocation structure generated by cyclically shifting the pilot allocation structure of FIG. 19(b) by one OFDM symbol. FIGS. 19(c) to 19(j) illustrate pilot allocation structures generated by cyclically shifting the pilot allocation structure of FIG. 19(a) by one subcarrier and then cyclically shifting the shifted pilot allocation structure by one OFDM symbol.

FIGS. 12 to 19 illustrate methods for cyclically shifting pilot symbols in the pilot allocation structures of FIGS. 12(a) and 19(a) sequentially on a 1 OFDM symbol basis or on a 1 subcarrier basis to generate new pilot allocation structures. The pilot symbols of FIGS. 12(a) and 19(a) may also be cyclically shifted sequentially on a 1 OFDM symbol basis and on a 1 subcarrier basis to generate new pilot allocation structures. The pilot allocation structures of FIGS. 12(a) and 19(a) may also be cyclically shifted sequentially on a 1 OFDM symbol basis and/or on a 2 or more subcarrier basis.

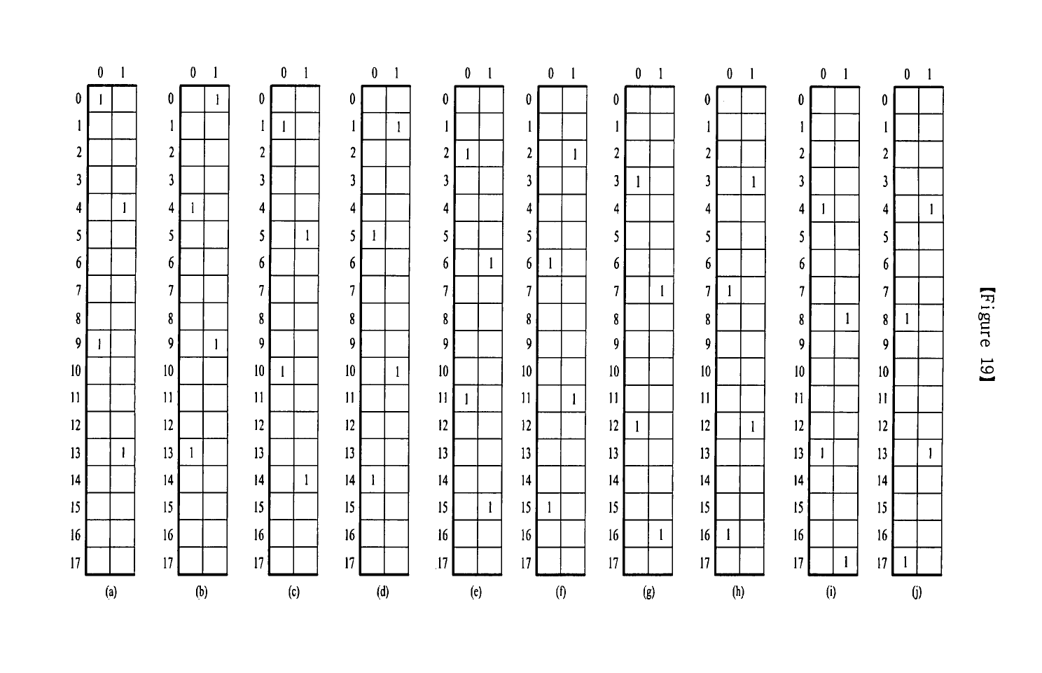

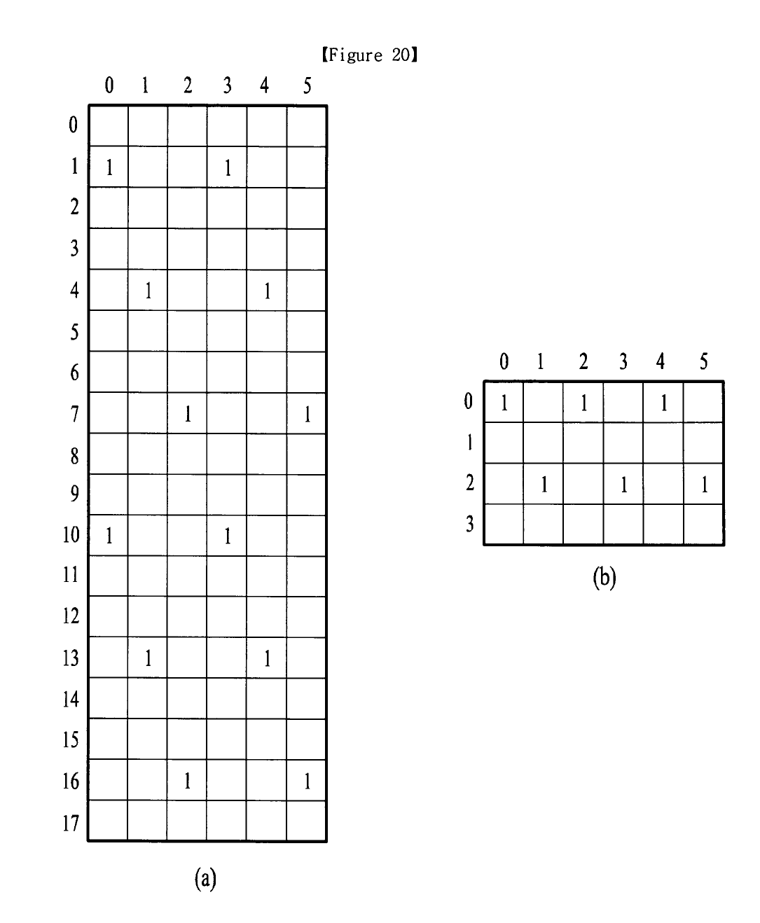

FIG. 20 illustrates another exemplary method for generating a new pilot allocation structure by cyclically shifting a pilot allocation structure according to the second embodiment of the present invention.

Specifically, FIG. 20(a) illustrates a pilot allocation structure in the case where the number of transmit antennas is 1, each RB has an 18×6 structure, and the rate of pilot symbol allocation in an RB is about 11.11%. In the pilot allocation structure of FIG. 20(a), two pilot symbols are allocated to each OFDM symbol at the pilot symbol allocation rate at intervals of 9 subcarriers and at intervals of 3 OFDM symbols.

The pilot allocation structure of FIG. 20(a) may be used in a 9×3 structure. For example, each pilot allocation structure may be divided into units at intervals of 9 subcarriers and 3 OFDM symbols and each unit may be used as an independent pilot allocation structure. In the case of FIG. 20(a), pilots are allocated such that the pilot pattern having the 9×3 structure is repeated twice.

FIG. 20(b) illustrates a pilot allocation structure in the case where the number of transmit antennas is 1, each RB has a 4×6 structure, and the rate of pilot symbol allocation in an RB is about 25%. In the pilot allocation structure of FIG. 20(b), one pilot symbol is allocated to each OFDM symbol while pilot symbols are allocated at intervals of two OFDM symbols at the same frequency.

New pilot allocation structures can be generated by cyclically shifting each of the pilot allocation structures of FIGS. 20(a) and 20(b) sequentially on a 1-OFDM symbol basis. New pilot allocation structures can also be generated by cyclically shifting each of the pilot allocation structures of FIGS. 20(a) and 20(b) sequentially on a 1 subcarrier basis. New pilot allocation structures can also be generated by cyclically shifting each of the pilot allocation structures of FIGS. 20(a) and 20(b) sequentially on a 1 OFDM symbol basis and on a 1 subcarrier basis.

In another method for cyclically shifting the pilot allocation structure of FIG. 20(a), new pilot allocation structures can be generated by cyclically shifting the pilot allocation structure of FIG. 20(a) to the upper or lower side on a 1 subcarrier basis. New pilot allocation structures can also be generated by cyclically shifting the pilot allocation structure of FIG. 20(a) to the right side on a 1 OFDM symbol basis. New pilot allocation structures can also be generated by cyclically shifting the pilot allocation structure of FIG. 20(a) on a 1 subcarrier basis and on a 1 OFDM symbol basis or by cyclically shifting it on a 1 subcarrier basis and on a 2 OFDM symbol basis or by cyclically shifting it on a 2 subcarrier basis and on a 1 OFDM symbol basis. Here, pilot symbols may be cyclically shifted in different directions. New pilot allocation structures can also be generated by cyclically shifting the pilot allocation structure of FIG. 20(a) on a 1 or more subcarrier basis and/or on a 1 or more OFDM symbol basis.

In the pilot allocation structure of FIG. 20(b), in the first subcarrier, pilot symbols are allocated to the first symbol, the third symbol, and the fifth symbol, respectively, and, in the third subcarrier, pilot symbols are allocated to the second symbol, the fourth symbol, and the sixth symbol, respectively. The pilot allocation structure of FIG. 20(b) may also be cyclically shifted to generate other new pilot allocation structures.

For example, the pilot allocation structure of FIG. 20(b) may be cyclically shifted on a 1 subcarrier basis or on a 1 OFDM symbol basis or may be cyclically shifted on a 1 subcarrier basis and on a 1 OFDM symbol basis to generate new pilot allocation structures.

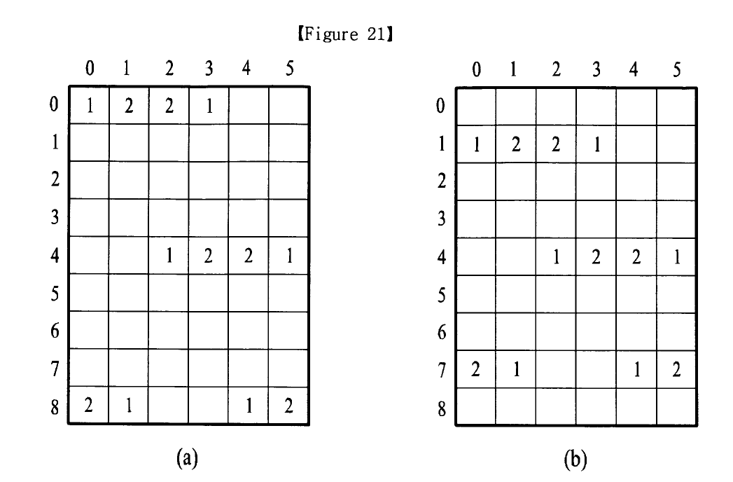

FIG. 21 illustrates an exemplary method for generating a new pilot allocation structure by cyclically shifting a pilot allocation structure according to a third embodiment of the present invention.

Specifically, FIG. 21 illustrates pilot allocation structures in the case where the number of transmit antennas is 2, each RB has a 9×6 structure, and the rate of pilot symbol allocation in an RB is about 22.22%. In the pilot allocation structures of FIG. 21, two pilot symbols, one for the first transmit antenna and the other for the second transmit antenna, are allocated to each OFDM symbol.

In the pilot allocation structure of FIG. 21(a), in the first OFDM symbol, a pilot symbol of the first transmit antenna is allocated to a Resource Element (RE) having a subcarrier index m of 0 and a pilot symbol of the second transmit antenna is allocated to an RE having a subcarrier index m of 8. In the second OFDM symbol, a pilot symbol of the second transmit antenna is allocated to an RE having a subcarrier index m of 0 and a pilot symbol of the first transmit antenna is allocated to an RE having a subcarrier index m of 8.

In the third OFDM symbol, a pilot symbol of the second transmit antenna is allocated to an RE having a subcarrier index m of 0 and a pilot symbol of the first transmit antenna is allocated to an RE having a subcarrier index m of 4. In the fourth OFDM symbol, a pilot symbol of the first transmit antenna is allocated to an RE having a subcarrier index m of 0 and a pilot symbol of the second transmit antenna is allocated to an RE having a subcarrier index m of 4.

In the fifth OFDM symbol, a pilot symbol of the second transmit antenna is allocated to an RE having a subcarrier index m of 4 and a pilot symbol of the first transmit antenna is allocated to an RE having a subcarrier index m of 8. In the sixth OFDM symbol, a pilot symbol of the first transmit antenna is allocated to an RE having a subcarrier index m of 4 and a pilot symbol of the second transmit antenna is allocated to an RE having a subcarrier index m of 8.

While the allocation positions of the pilot allocation structure of FIG. 21(a) may be cyclically shifted on a 1 or more OFDM symbol basis to generate new pilot allocation structures, the allocation positions of the pilot allocation structure of FIG. 21(a) may also be cyclically shifted on a 2 OFDM symbol or 4 OFDM symbol basis to generate new pilot allocation structures.

The pilot allocation structure of FIG. 21(b) is generated by replacing the allocation positions of pilot symbols, which have been allocated to REs having a subcarrier index of 0, with REs having a subcarrier index of 1 and replacing the allocation positions of pilot symbols, which have been allocated to REs having a subcarrier index of 8, with REs having a subcarrier index of 7.

In the third embodiment of the present invention, the pilot allocation structure of FIG. 21(b) may be cyclically shifted according to a variety of methods to generate new pilot allocation structures.

For example, the pilot allocation structure of FIG. 21(b) may be cyclically shifted to the upper or lower side on a 1 subcarrier basis to generate new pilot allocation structures. The pilot allocation structure of FIG. 21(b) may also be cyclically shifted to the left or right side on a 2 OFDM symbol basis to generate new pilot allocation structures. The pilot allocation structure of FIG. 21(b) may also be cyclically shifted to the lower side on a 1 subcarrier basis and then be cyclically shifted to the right side on a 2 OFDM symbol basis to generate new pilot allocation structures. The pilot allocation structure of FIG. 21(b) may also be cyclically shifted to the left or right side on a 4 OFDM symbol basis to generate new pilot allocation structures. The pilot allocation structure of FIG. 21(b) may also be cyclically shifted to the left or right side on a 4 OFDM symbol basis and then be cyclically shifted to the upper or lower side on a 1 subcarrier basis or on a 2 subcarrier basis to generate new pilot allocation structures.

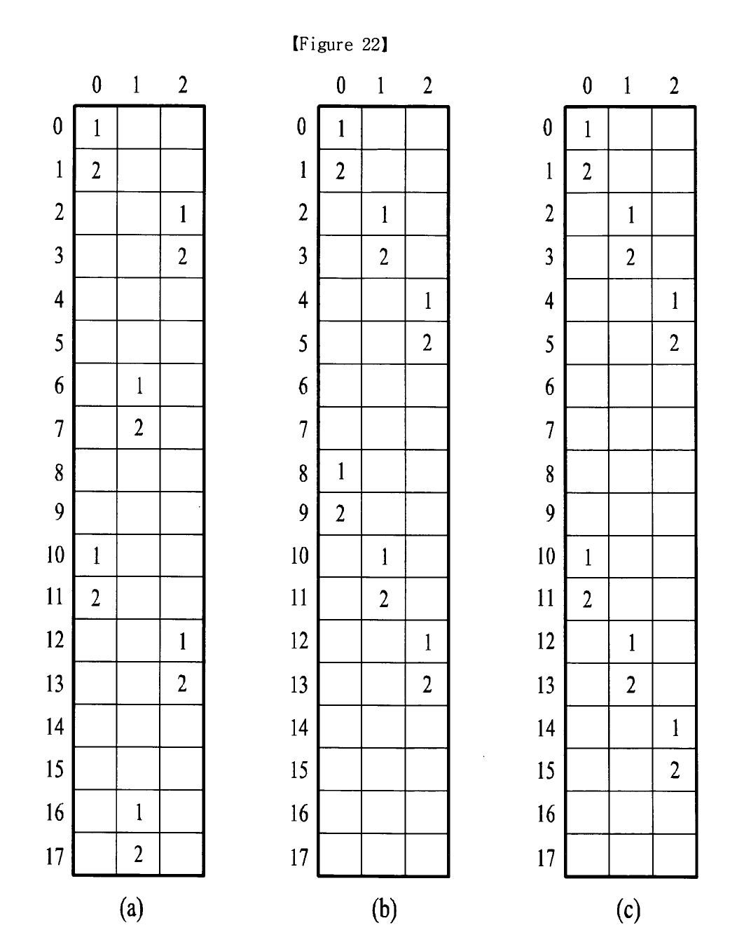

FIG. 22 illustrates another exemplary method for generating a new pilot allocation structure by cyclically shifting a pilot allocation structure according to the third embodiment of the present invention.

The pilot allocation structures of FIG. 22 are identical to those of FIG. 9, respectively. However, the pilot allocation structures of FIG. 22 are illustrated to explain how each pilot allocation structure is cyclically shifted to generate new pilot allocation structures.

The user may cyclically shift the pilot allocation structure of FIG. 22(a) on a 1 or 2 OFDM symbol basis to generate a new pilot allocation structure. The user may also shift the pilot allocation structure of FIG. 22(a) on a 1 or more subcarrier basis.

The user may also exchange the position of the first OFDM symbol with the position of the second OFDM symbol in the pilot allocation structure of FIG. 22(a), exchange the position of the second OFDM symbol with the position of the third OFDM symbol, or exchange the position of the first OFDM symbol with the position of the third OFDM symbol to obtain a pilot allocation structure with shifted allocation positions of pilot symbols. The user may also cyclically shift each pilot allocation structure on a 1 or 2 OFDM symbol basis after changing positions of OFDM symbols to generate a new pilot allocation structure.

The user may also cyclically shift the pilot allocation structure of FIG. 22(b) on a 1 or 2 OFDM symbol basis. The user may cyclically shift the pilot allocation structure on a 1 or more subcarrier basis (preferably, on a 2 or 4 subcarrier basis). The user may cyclically shift the pilot allocation structure on a 1 OFDM symbol basis and on a 2 subcarrier basis and may cyclically shift the pilot allocation structure on a 2 OFDM symbol basis and on a 2 subcarrier basis. The user may cyclically shift the pilot allocation structure on a 1 OFDM symbol basis and on a 4 subcarrier basis and may cyclically shift the pilot allocation structure on a 2 OFDM symbol basis and on a 4 subcarrier basis.

The user may also cyclically shift the pilot allocation structure of FIG. 22(c) on a 1 or 2 OFDM symbol basis. The user may cyclically shift the pilot allocation structure of FIG. 22(c) on a 2 subcarrier basis. The user may cyclically shift the pilot allocation structure on a 1 OFDM symbol basis and on a 2 subcarrier basis. The user may also cyclically shift the pilot allocation structure on a 2 OFDM symbol basis and on a 2 subcarrier basis to generate a new pilot allocation structure.

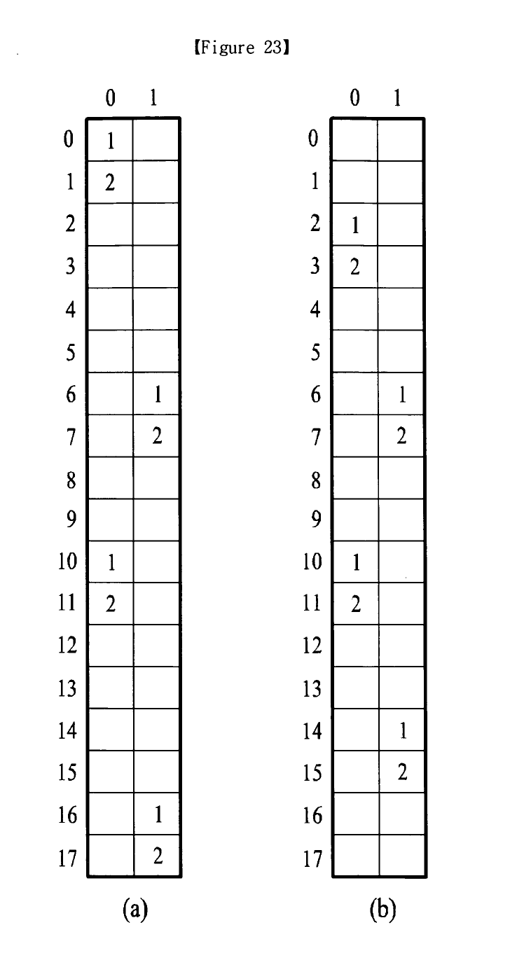

FIG. 23 illustrates another exemplary method for generating a new pilot allocation structure by cyclically shifting a pilot allocation structure according to the third embodiment of the present invention.

The pilot allocation structures of FIG. 23 are identical to those of FIG. 10, respectively. The user may change each pilot allocation structure of FIG. 23 by cyclically shifting pilot symbols allocated in the pilot allocation structure on a 1 OFDM symbol basis. The user may also cyclically shift each pilot allocation structure of FIG. 23 on a 1 or more subcarrier basis (preferably, on a 2 subcarrier basis) to generate a new pilot allocation structure. The user may also cyclically shift each pilot allocation structure of FIG. 23 on a 1 or more subcarrier basis (preferably, on a 2 subcarrier basis) to generate a new pilot allocation structure. The user may also cyclically shifting pilot symbols allocated in each pilot allocation structure of FIG. 23 on a 1 OFDM symbol basis and on a 2 subcarrier basis to generate a new pilot allocation structure.

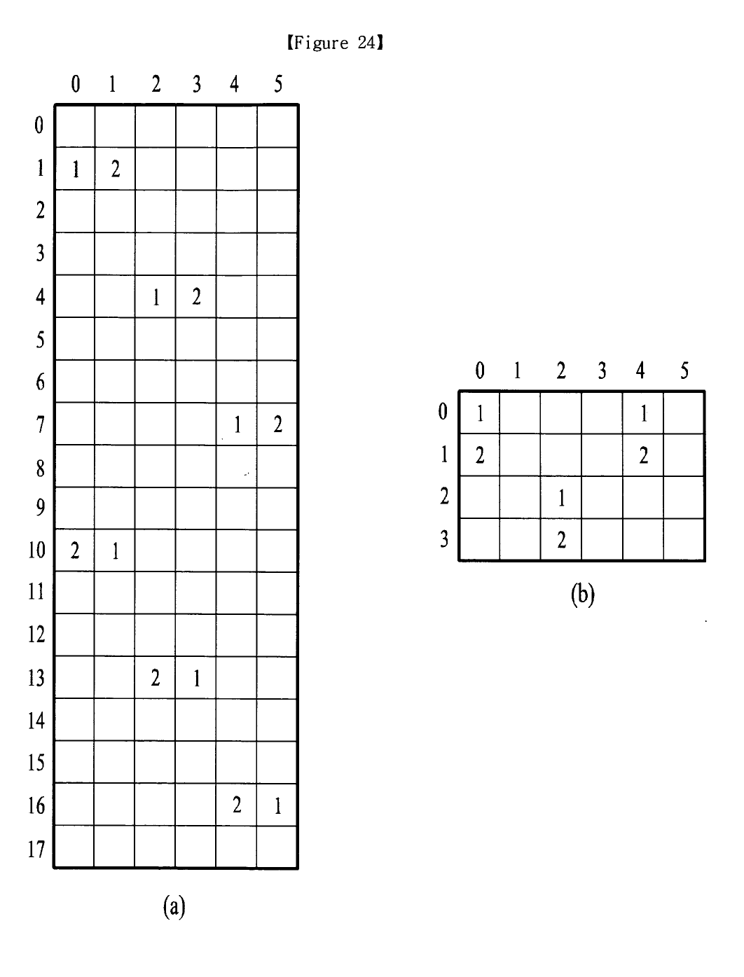

FIG. 24 illustrates another exemplary method for generating a new pilot allocation structure by cyclically shifting a pilot allocation structure according to the third embodiment of the present invention.

Specifically, FIG. 24(a) illustrates a pilot allocation structure in the case where the number of transmit antennas is 2, each RB has an 18×6 structure, and the rate of pilot symbol allocation in an RB is about 11.11%. In the pilot allocation structure of FIG. 24(a), a pilot symbol of the first transmit antenna and a pilot symbol of the second transmit antenna are allocated to each OFDM symbol.

In the first OFDM symbol (n=0), a pilot symbol of the first transmit antenna is allocated to a Resource Element (RE) having a subcarrier index m of 1 and a pilot symbol of the second transmit antenna is allocated to an RE having a subcarrier index m of 10. In the second OFDM symbol (n=1), a pilot symbol of the second transmit antenna is allocated to an RE having a subcarrier index m of 1 and a pilot symbol of the first transmit antenna is allocated to an RE having a subcarrier index m of 10.

In the third OFDM symbol (n=2), a pilot symbol of the first transmit antenna is allocated to an RE having a subcarrier index m of 4 and a pilot symbol of the second transmit antenna is allocated to an RE having a subcarrier index m of 13. In the fourth OFDM symbol (n=3), a pilot symbol of the second transmit antenna is allocated to an RE having a subcarrier index m of 4 and a pilot symbol of the first transmit antenna is allocated to an RE having a subcarrier index m of 13.

In the fifth OFDM symbol (n=4), a pilot symbol of the first transmit antenna is allocated to an RE having a subcarrier index m of 7 and a pilot symbol of the second transmit antenna is allocated to an RE having a subcarrier index m of 16. In the sixth OFDM symbol (n=5), a pilot symbol of the second transmit antenna is allocated to an RE having a subcarrier index m of 7 and a pilot symbol of the first transmit antenna is allocated to an RE having a subcarrier index m of 16.

The following are exemplary methods for cyclically shifting the pilot allocation structure of FIG. 24(a).

The user may cyclically shift the pilot symbols of the pilot allocation structure of FIG. 24(a) to the right side on a 1 or more OFDM symbol basis (preferably, on a 2 or 4 OFDM symbol basis) or may cyclically shift the pilot symbols to the lower or upper side on a 1 or more subcarrier basis to generate a new pilot allocation structure. In addition, the user may cyclically shift the pilot symbols on a 2 OFDM symbol basis and on a 1 subcarrier basis or may cyclically shift the pilot symbols on a 2 OFDM symbol basis and on a 2 subcarrier basis to generate a new pilot allocation structure.

In addition, the user may cyclically shift the pilot symbols on a 4 OFDM symbol basis and on a 1 subcarrier basis or may cyclically shift the pilot symbols on a 4 OFDM symbol basis and on a 2 subcarrier basis to generate a new pilot allocation structure.

FIG. 24(b) illustrates a pilot allocation structure in the case where the number of transmit antennas is 2, each RB has a 4×6 structure, and the rate of pilot symbol allocation in an RB is about 25%. In the pilot allocation structure of FIG. 24(b), a pilot symbol of the first transmit antenna and a pilot symbol of the second transmit antenna are allocated to specific OFDM symbols.

In the pilot allocation structure of FIG. 24(b), in the first OFDM symbol (n=0), a pilot symbol of the first transmit antenna is allocated to a Resource Element (RE) having a subcarrier index m of 0 and a pilot symbol of the second transmit antenna is allocated to an RE having a subcarrier index m of 1. In the third OFDM symbol (n=2), a pilot symbol of the first transmit antenna is allocated to an RE having a subcarrier index m of 2 and a pilot symbol of the second transmit antenna is allocated to an RE having a subcarrier index m of 1. In the fifth OFDM symbol (n=4), a pilot symbol of the first transmit antenna is allocated to an RE having a subcarrier index m of 0 and a pilot symbol of the second transmit antenna is allocated to an RE having a subcarrier index m of 1.

The pilot symbols of the pilot allocation structure of FIG. 24(b) may be cyclically shifted on a 1 or more OFDM symbol basis. The pilot symbols may also be cyclically shifted on a 1 or more subcarrier basis according to user requirements.

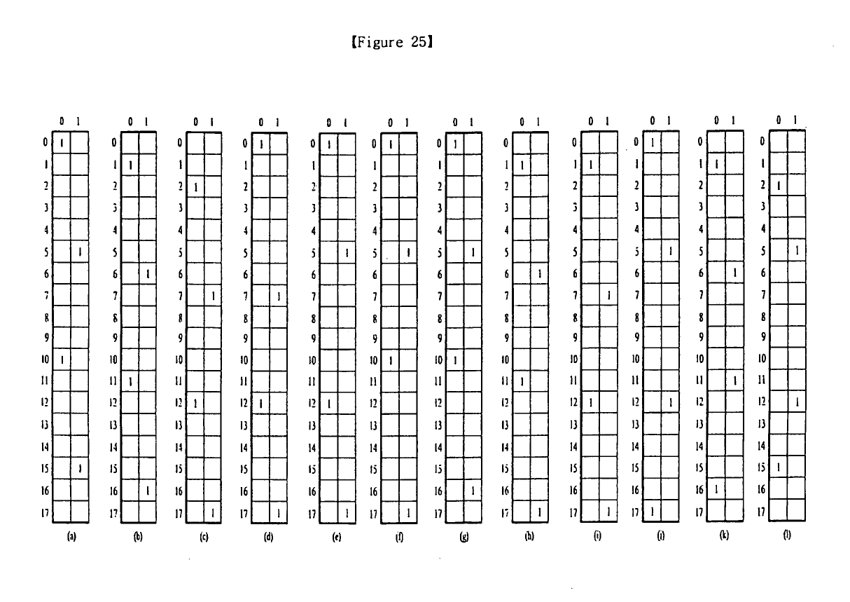

FIG. 25 illustrates a variety of pilot allocation structures according to the third embodiment of the present invention.

Specifically, FIG. 25 illustrates pilot allocation structures in the case where the number of transmit antennas is 1, each RB has an 18×2 structure, the rate of pilot symbol allocation in an RB is about 11.11%, and two pilot symbols are allocated to each OFDM symbol.

In the pilot allocation structure of FIG. 25(a), pilot symbols are allocated respectively to Resource Elements (REs) having subcarrier indices m of 0 and 10 in the first OFDM symbol (n=0) and pilot symbols are allocated respectively to REs having subcarrier indices m of 5 and 15 in the second OFDM symbol (n=1).

The pilot allocation structure of FIG. 25(b) is generated by cyclically shifting the pilot symbols of the pilot allocation structure of FIG. 25(a) to the lower side by one subcarrier and the pilot allocation structure of FIG. 25(c) is generated by cyclically shifting the pilot symbols of the pilot allocation structure of FIG. 25(b) to the lower side by one subcarrier.

In the pilot allocation structure of FIG. 25(d), pilot symbols are allocated respectively to Resource Elements (REs) having subcarrier indices m of 0 and 12 in the first OFDM symbol (n=0) and pilot symbols are allocated respectively to REs having subcarrier indices m of 7 and 17 in the second OFDM symbol (n=1).

In the pilot allocation structure of FIG. 25(e), pilot symbols are allocated respectively to Resource Elements (REs) having subcarrier indices m of 0 and 12 in the first OFDM symbol (n=0) and pilot symbols are allocated respectively to REs having subcarrier indices m of 5 and 17 in the second OFDM symbol (n=1).

In the pilot allocation structure of FIG. 25(f), pilot symbols are allocated respectively to Resource Elements (REs) having subcarrier indices m of 0 and 10 in the first OFDM symbol (n=0) and pilot symbols are allocated respectively to REs having subcarrier indices m of 5 and 17 in the second OFDM symbol (n=1).

In the pilot allocation structure of FIG. 25(g), pilot symbols are allocated respectively to Resource Elements (REs) having subcarrier indices m of 0 and 10 in the first OFDM symbol (n=0) and pilot symbols are allocated respectively to REs having subcarrier indices m of 5 and 16 in the second OFDM symbol (n=1).

In the pilot allocation structure of FIG. 25(h), pilot symbols are allocated respectively to Resource Elements (REs) having subcarrier indices m of 1 and 11 in the first OFDM symbol (n=0) and pilot symbols are allocated respectively to REs having subcarrier indices m of 6 and 17 in the second OFDM symbol (n=1).

In the pilot allocation structure of FIG. 25(i), pilot symbols are allocated respectively to Resource Elements (REs) having subcarrier indices m of 1 and 12 in the first OFDM symbol (n=0) and pilot symbols are allocated respectively to REs having subcarrier indices m of 7 and 17 in the second OFDM symbol (n=1).

In the pilot allocation structure of FIG. 25(j), pilot symbols are allocated respectively to Resource Elements (REs) having subcarrier indices m of 0 and 17 in the first OFDM symbol (n=0) and pilot symbols are allocated respectively to REs having subcarrier indices m of 5 and 12 in the second OFDM symbol (n=1).

In the pilot allocation structure of FIG. 25(k), pilot symbols are allocated respectively to Resource Elements (REs) having subcarrier indices m of 1 and 16 in the first OFDM symbol (n=0) and pilot symbols are allocated respectively to REs having subcarrier indices m of 6 and 11 in the second OFDM symbol (n=1).

In the pilot allocation structure of FIG. 25(l), pilot symbols are allocated respectively to Resource Elements (REs) having subcarrier indices m of 2 and 15 in the first OFDM symbol (n=0) and pilot symbols are allocated respectively to REs having subcarrier indices m of 5 and 12 in the second OFDM symbol (n=1).

The pilot allocation structures of FIG. 25 have an RB size of 18×2. However, one OFDM symbol may be added to each of the 18×2 pilot allocation structures of FIG. 25 to extend the pilot allocation structure to an 18×3 pilot allocation structure. For example, a middle data symbol column may be added or a first data symbol column or a second data symbol column may be added to each of the pilot allocation structures of FIG. 25 to generate a new 18×3 pilot allocation structure.

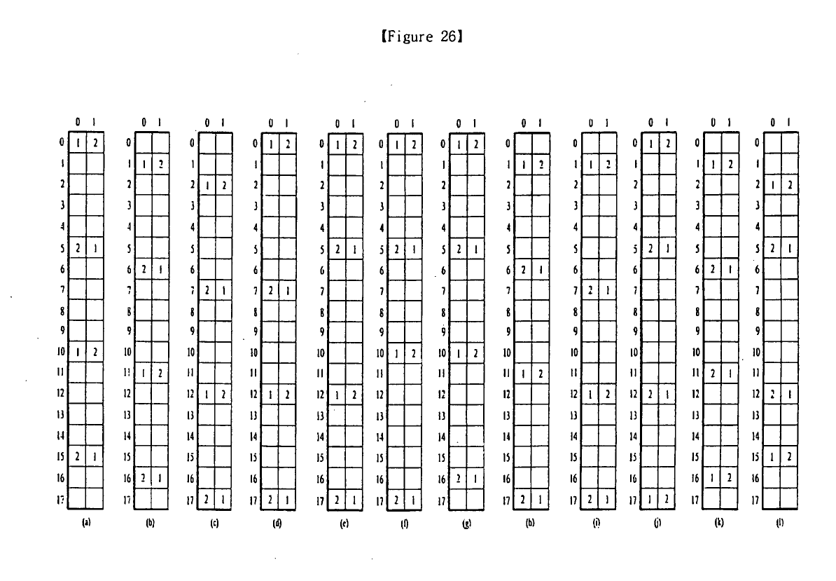

FIG. 26 illustrates a variety of pilot allocation structures according to the third embodiment of the present invention.

Specifically, FIG. 26 illustrates pilot allocation structures in the case where the number of transmit antennas is 2, each RB has an 18×2 structure, the rate of pilot symbol allocation in an RB is about 22.22%, and pilot symbols of each of the antennas are allocated to each OFDM symbol.

In the pilot allocation structure of FIG. 26(a), pilot symbols of the first transmit antenna are allocated respectively to Resource Elements (REs) having subcarrier indices m of 1 and 10 in the first OFDM symbol (n=0) and pilot symbols of the second transmit antenna are allocated respectively to REs having subcarrier indices m of 5 and 15 in the first OFDM symbol. In addition, pilot symbols of the second transmit antenna are allocated respectively to Resource Elements (REs) having subcarrier indices m of 0 and 10 in the second OFDM symbol (n=1) and pilot symbols of the first transmit antenna are allocated respectively to REs having subcarrier indices m of 5 and 15 in the second OFDM symbol.

The pilot allocation structures of FIGS. 26(b) and 26(c) are generated by cyclically shifting the pilot symbols of the pilot allocation structure of FIG. 26(a) sequentially on a 1 subcarrier basis.

In the pilot allocation structure of FIG. 26(d), pilot symbols of the first transmit antenna are allocated respectively to Resource Elements (REs) having subcarrier indices m of 1 and 12 in the first OFDM symbol (n=0) and pilot symbols of the second transmit antenna are allocated respectively to REs having subcarrier indices m of 7 and 17 in the first OFDM symbol. In addition, pilot symbols of the second transmit antenna are allocated respectively to Resource Elements (REs) having subcarrier indices m of 0 and 12 in the second OFDM symbol (n=1) and pilot symbols of the first transmit antenna are allocated respectively to REs having subcarrier indices m of 7 and 17 in the second OFDM symbol.

In the pilot allocation structure of FIG. 26(e), pilot symbols of the first transmit antenna are allocated respectively to Resource Elements (REs) having subcarrier indices m of 0 and 12 in the first OFDM symbol (n=0) and pilot symbols of the second transmit antenna are allocated respectively to REs having subcarrier indices m of 5 and 17 in the first OFDM symbol. In addition, pilot symbols of the second transmit antenna are allocated respectively to Resource Elements (REs) having subcarrier indices m of 0 and 12 in the second OFDM symbol (n=1) and pilot symbols of the first transmit antenna are allocated respectively to REs having subcarrier indices m of 5 and 17 in the second OFDM symbol.

In the pilot allocation structure of FIG. 26(f), pilot symbols of the first transmit antenna are allocated respectively to Resource Elements (REs) having subcarrier indices m of 0 and 10 in the first OFDM symbol (n=0) and pilot symbols of the second transmit antenna are allocated respectively to REs having subcarrier indices m of 5 and 17 in the first OFDM symbol. In addition, pilot symbols of the second transmit antenna are allocated respectively to Resource Elements (REs) having subcarrier indices m of 0 and 10 in the second OFDM symbol (n=1) and pilot symbols of the first transmit antenna are allocated respectively to REs having subcarrier indices m of 5 and 17 in the second OFDM symbol.

In the pilot allocation structure of FIG. 26(g), pilot symbols of the first transmit antenna are allocated respectively to Resource Elements (REs) having subcarrier indices m of 0 and 10 in the first OFDM symbol (n=0) and pilot symbols of the second transmit antenna are allocated respectively to REs having subcarrier indices m of 5 and 16 in the first OFDM symbol. In addition, pilot symbols of the second transmit antenna are allocated respectively to Resource Elements (REs) having subcarrier indices m of 0 and 10 in the second OFDM symbol (n=1) and pilot symbols of the first transmit antenna are allocated respectively to REs having subcarrier indices m of 5 and 16 in the second OFDM symbol.

The pilot allocation structure of FIG. 26(h) is generated by cyclically shifting the pilot symbols of the pilot allocation structure of FIG. 26(g) by one subcarrier.

In the pilot allocation structure of FIG. 26(i), pilot symbols of the first transmit antenna are allocated respectively to Resource Elements (REs) having subcarrier indices m of 1 and 12 in the first OFDM symbol (n=0) and pilot symbols of the second transmit antenna are allocated respectively to REs having subcarrier indices m of 7 and 17 in the first OFDM symbol. In addition, pilot symbols of the second transmit antenna are allocated respectively to Resource Elements (REs) having subcarrier indices m of 1 and 12 in the second OFDM symbol (n=1) and pilot symbols of the first transmit antenna are allocated respectively to REs having subcarrier indices m of 6 and 17 in the second OFDM symbol.

In the pilot allocation structure of FIG. 26(j), pilot symbols of the first transmit antenna are allocated respectively to Resource Elements (REs) having subcarrier indices m of 0 and 17 in the first OFDM symbol (n=0) and pilot symbols of the second transmit antenna are allocated respectively to REs having subcarrier indices m of 5 and 12 in the first OFDM symbol. In addition, pilot symbols of the second transmit antenna are allocated respectively to Resource Elements (REs) having subcarrier indices m of 0 and 17 in the second OFDM symbol (n=1) and pilot symbols of the first transmit antenna are allocated respectively to REs having subcarrier indices m of 5 and 12 in the second OFDM symbol.

In the pilot allocation structure of FIG. 26(k), pilot symbols of the first transmit antenna are allocated respectively to Resource Elements (REs) having subcarrier indices m of 1 and 16 in the first OFDM symbol (n=0) and pilot symbols of the second transmit antenna are allocated respectively to REs having subcarrier indices m of 6 and 11 in the first OFDM symbol. In addition, pilot symbols of the second transmit antenna are allocated respectively to Resource Elements (REs) having subcarrier indices m of 1 and 16 in the second OFDM symbol (n=1) and pilot symbols of the first transmit antenna are allocated respectively to REs having subcarrier indices m of 6 and 11 in the second OFDM symbol.

In the pilot allocation structure of FIG. 26(l), pilot symbols of the first transmit antenna are allocated respectively to Resource Elements (REs) having subcarrier indices m of 1 and 15 in the first OFDM symbol (n=0) and pilot symbols of the second transmit antenna are allocated respectively to REs having subcarrier indices m of 5 and 12 in the first OFDM symbol. In addition, pilot symbols of the second transmit antenna are allocated respectively to Resource Elements (REs) having subcarrier indices m of 2 and 15 in the second OFDM symbol (n=1) and pilot symbols of the first transmit antenna are allocated respectively to REs having subcarrier indices m of 5 and 12 in the second OFDM symbol.

The pilot allocation structures of FIG. 26 have an RB size of 18×2. However, one OFDM symbol may be added to each of the 18×2 pilot allocation structures of FIG. 26 to extend the pilot allocation structure to an 18×3 pilot allocation structure. For example, a middle data symbol column may be added or a first data symbol column or a second data symbol column may be added to each of the pilot allocation structures of FIG. 26 to generate a new 18×3 pilot allocation structure.

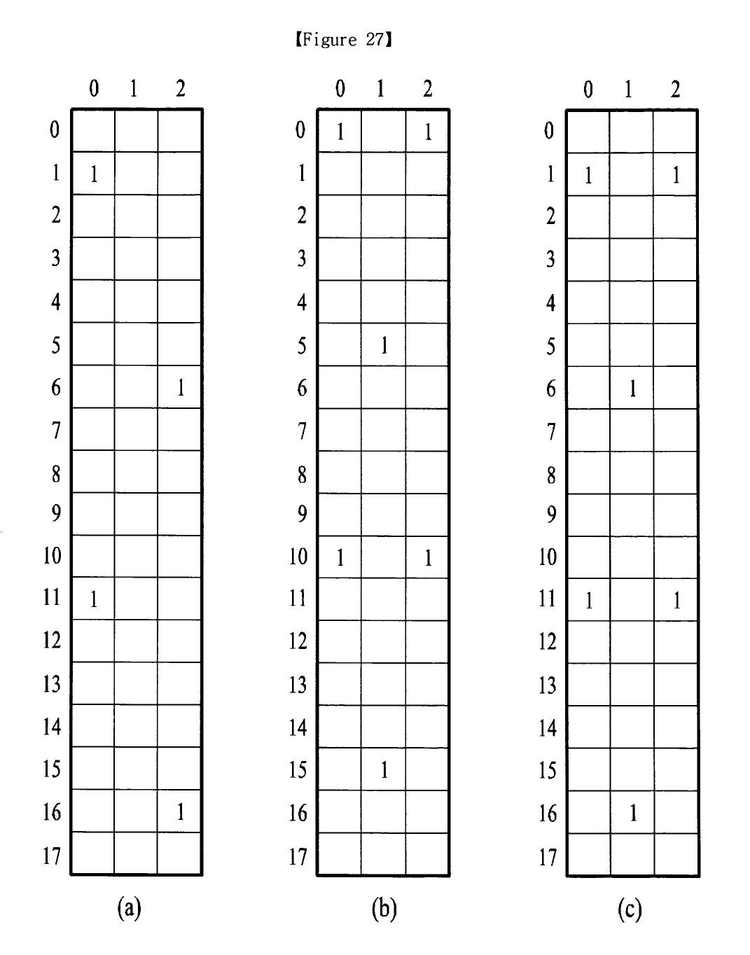

FIG. 27 illustrates a variety of pilot allocation structures according to the third embodiment of the present invention.

Specifically, FIG. 27(a) illustrates a pilot allocation structure in the case where the number of transmit antennas is 1, each RB has an 18×3 structure, and the rate of pilot symbol allocation in an RB is about 7.40%.

In the pilot allocation structure of FIG. 27(a), pilot symbols are allocated respectively to Resource Elements (REs) having subcarrier indices m of 1 and 11 in the first OFDM symbol (n=0) and pilot symbols are allocated respectively to Resource Elements (REs) having subcarrier indices m of 6 and 16 in the third OFDM symbol (n=2) as shown in FIG. 27(a).

FIGS. 27(b) and 27(c) illustrate pilot allocation structures in the case where the number of transmit antennas is 1, each RB has an 18×3 structure, and the rate of pilot symbol allocation in an RB is about 11.11%.

In the pilot allocation structure of FIG. 27(b), pilot symbols are allocated respectively to Resource Elements (REs) having subcarrier indices m of 0 and 10 in the first OFDM symbol (n=0) and the third OFDM symbol (n=2) and pilot symbols are allocated respectively to Resource Elements (REs) having subcarrier indices m of 5 and 15 in the second OFDM symbol (n=1) as shown in FIG. 27(b).

The pilot allocation structure of FIG. 27(c) is generated by cyclically shifting the pilot symbols of the pilot allocation structure of FIG. 27(b) to the lower side by one subcarrier.

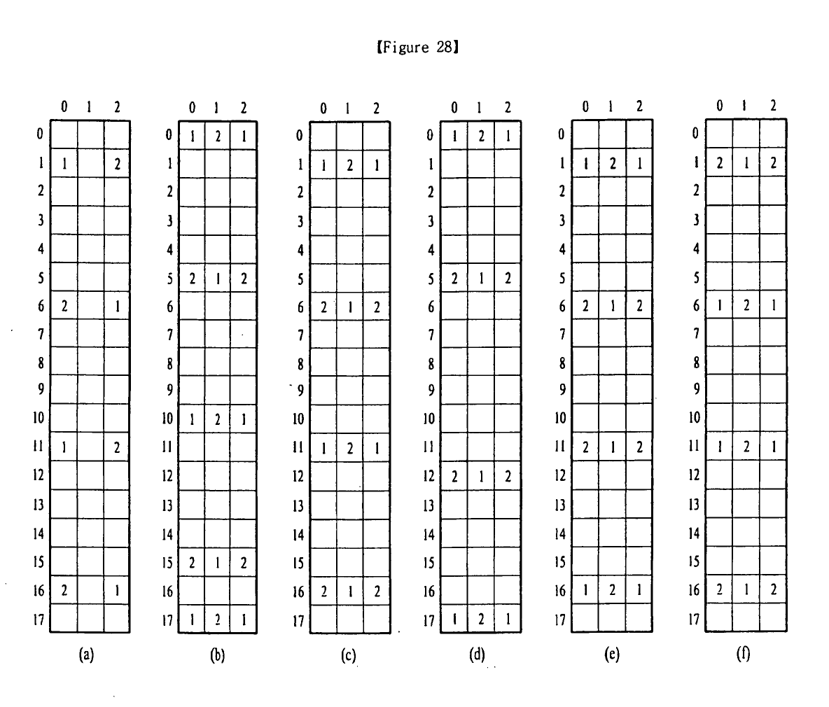

FIG. 28 illustrates a variety of pilot allocation structures according to the third embodiment of the present invention.

Specifically, FIG. 28(a) illustrates a pilot allocation structure in the case where the number of transmit antennas is 2, each RB has an 18×3 structure, and the rate of pilot symbol allocation in an RB is about 14.81%.

In the pilot allocation structure of FIG. 28(a), pilot symbols of the first transmit antenna are allocated respectively to Resource Elements (REs) having subcarrier indices m of 1 and 11 in the first OFDM symbol (n=0) and pilot symbols of the second transmit antenna are allocated respectively to Resource Elements (REs) having subcarrier indices m of 6 and 16 in the first OFDM symbol. In addition, pilot symbols of the second transmit antenna are allocated respectively to Resource Elements (REs) having subcarrier indices m of 1 and 11 in the third OFDM symbol (n=2) and pilot symbols of the first transmit antenna are allocated respectively to Resource Elements (REs) having subcarrier indices m of 6 and 16 in the third OFDM symbol.

FIGS. 28(b) to 28(f) illustrate pilot allocation structures in the case where the number of transmit antennas is 2, each RB has an 18×3 structure, and the rate of pilot symbol allocation in an RB is about 22.22%.

In the pilot allocation structure of FIG. 28(b), pilot symbols of the first transmit antenna are allocated respectively to Resource Elements (REs) having subcarrier indices m of 1 and 10 in the first OFDM symbol (n=0) and the third OFDM symbol (n=2) and pilot symbols of the second transmit antenna are allocated respectively to Resource Elements (REs) having subcarrier indices m of 5 and 15 in the first and third OFDM symbols. In addition, pilot symbols of the second transmit antenna are allocated respectively to Resource Elements (REs) having subcarrier indices m of 0 and 10 in the second OFDM symbol (n=1) and pilot symbols of the first transmit antenna are allocated respectively to Resource Elements (REs) having subcarrier indices m of 5 and 15 in the second OFDM symbol.

The pilot allocation structure of FIG. 28(c) is generated by cyclically shifting the pilot symbols of the pilot allocation structure of FIG. 28(b) by one subcarrier.

In the pilot allocation structure of FIG. 28(d), pilot symbols of the first transmit antenna are allocated respectively to Resource Elements (REs) having subcarrier indices m of 0 and 17 in the first OFDM symbol (n=0) and the third OFDM symbol (n=2) and pilot symbols of the second transmit antenna are allocated respectively to Resource Elements (REs) having subcarrier indices m of 5 and 12 in the first and third OFDM symbols as shown in FIG. 28(d). In addition, pilot symbols of the second transmit antenna are allocated respectively to Resource Elements (REs) having subcarrier indices m of 0 and 17 in the second OFDM symbol (n=1) and pilot symbols of the first transmit antenna are allocated respectively to Resource Elements (REs) having subcarrier indices m of 5 and 12 in the second OFDM symbol.

In the pilot allocation structure of FIG. 28(e), pilot symbols of the first transmit antenna are allocated respectively to Resource Elements (REs) having subcarrier indices m of 1 and 16 in the first OFDM symbol (n=0) and the third OFDM symbol (n=2) and pilot symbols of the second transmit antenna are allocated respectively to Resource Elements (REs) having subcarrier indices m of 6 and 11 in the first and third OFDM symbols. In addition, pilot symbols of the second transmit antenna are allocated respectively to Resource Elements (REs) having subcarrier indices m of 1 and 16 in the second OFDM symbol (n=1) and pilot symbols of the first transmit antenna are allocated respectively to Resource Elements (REs) having subcarrier indices m of 6 and 11 in the second OFDM symbol.

In the pilot allocation structure of FIG. 28(f), pilot symbols of the second transmit antenna are allocated respectively to Resource Elements (REs) having subcarrier indices m of 1 and 16 in the first OFDM symbol (n=0) and the third OFDM symbol (n=2) and pilot symbols of the first transmit antenna are allocated respectively to Resource Elements (REs) having subcarrier indices m of 6 and 11 in the first and third OFDM symbols. In addition, pilot symbols of the first transmit antenna are allocated respectively to Resource Elements (REs) having subcarrier indices m of 1 and 16 in the second OFDM symbol (n=1) and pilot symbols of the second transmit antenna are allocated respectively to Resource Elements (REs) having subcarrier indices m of 6 and 11 in the second OFDM symbol.

The accompanying drawings, which illustrate the embodiments of the present invention in detail, may be modified to various other forms. For example, although the drawings do not illustrate all pilot allocation structures that can be obtained by cyclically shifting the pilot allocation structures to which the technical features of the present invention are applied, all possible pilot allocation structures can be obtained by combining the technical features of the pilot allocation structures of the drawings.

That is, the present invention also provides pilot allocation structures that can be generated by cyclically shifting the pilot symbols included in each of the pilot allocation structures described above on a 1 or more OFDM symbol basis and/or on a 1 or more subcarrier basis.

*290In addition to the pilot allocation structures and the pilot allocation methods described above, the present invention provides a method which allows the pilot allocation methods, which are applied to the case where the number of transmit antennas is 2, to be used in the case where the number of transmit antennas is 4 or in the case where the number of transmit antennas is 2 and one or more terminals share resources.

Generally, pilots of terminals (users) for spatial multiplexing or antennas are discriminated in the time/frequency domains. In this case, pilot overhead increases as the number of antennas or the number of terminals (users) that share resources increases. Channel estimation capabilities can be improved if pilot overhead is maintained at a low level even though the number of antennas or the number of terminals (users) that share resources has increased. The present invention provides antenna pilot allocation methods which have the same channel estimation capabilities while maintaining pilot overhead at a relatively low level in consideration of such trade-off.

In the embodiments of the present invention, the base station has a predefined phase shift code set and discriminates pilots allocated to the same position (or channel information estimated through the same) using the phase shift code set. For example, in the case of a system with four transmit antennas, a pilot allocation structure for two transmit antennas can be used for pilot allocation of the first and second transmit antennas of the four transmit antennas. In addition, a pilot allocation structure, in which the same pilot allocation positions as those of the first and second transmit antennas are masked with predefined phase shift codes for discrimination from those of the first and second transmit antennas, can be used for pilot allocation of the third and fourth transmit antennas. In the case of a system in which the same resources are shared and used for transmission, antennas can be discriminated in the time/frequency domains and the terminals (users) can be discriminated using phase shift codes.

### MODE FOR INVENTION

Various embodiments have been described in the best mode for carrying out the invention.

The present invention may be embodied in other specific forms than those set forth herein without departing from the spirit and essential characteristics of the present invention. The above description is therefore to be construed in all aspects as illustrative and not restrictive. The scope of the invention should be determined by reasonable interpretation of the appended claims and all changes coming within the equivalency range of the invention are intended to be embraced in the scope of the invention. In addition, claims which are not explicitly dependent on each other can be combined to provide an embodiment or new claims can be added through amendment after this application is filed.

### INDUSTRIAL APPLICABILITY

The embodiments of the present invention can be applied to a variety of wireless access systems. Examples of the variety of wireless access systems include 3rd Generation Partnership Project (3GPP), 3GPP2, and/or Institute of Electrical and Electronic Engineers (IEEE) 802.xx systems. The embodiments of the present invention can be applied not only to the variety of wireless access systems but also to any technical fields to which the variety of wireless access systems are applied.

1. A method for transmitting and receiving data in a wireless access system, the method comprising:
transmitting data using a resource block constructed taking into consideration channel estimation capabilities and data transfer rate; and
receiving data using the resource block,
wherein the resource block includes a predetermined number of pilot symbols constructed in a predetermined pattern and the pilot symbols are allocated to the resource block at a predetermined allocation rate taking into consideration a number of transmit antennas.

2. The method according to claim 1, wherein a structure of subcarriers and OFDM symbols of the resource block is one of a 9? structure, a 9? structure, and a 9? structure.

3. The method according to claim 1, wherein a structure of subcarriers and OFDM symbols of the resource block is one of an 18? structure, an 18? structure, an 18? structure, and a 4? structure.

4. The method according to claim 1, wherein the pilot symbols are allocated at intervals of 2 OFDM symbols or at intervals of 3 OFDM symbols taking into consideration a coherent time of a moving speed of a terminal.

5. The method according to claim 1, wherein the pilot symbols are allocated at intervals of 8 subcarriers or at intervals of 9 subcarriers taking into consideration frequency-selective characteristics.

6. The method according to claim 1, wherein, when a number of transmit antennas is 1, the predetermined allocation rate of the pilot symbols is in a range of substantially 11.11% to substantially 16.67%.

7. The method according to claim 1, wherein, when a number of transmit antennas is 2, the predetermined allocation rate of the pilot symbols is in a range of substantially 11.11% to substantially 22.22%.

8. The method according to claim 1, wherein the same number of pilot symbols are allocated to each OFDM symbol included in the resource block.

9. The method according to claim 1 or 8, wherein, for boosting power of the pilot symbols, power is borrowed from at least one data symbol included in each OFDM symbol to which the pilot symbols are allocated.

10. The method according to claim 1, wherein the transmit antenna supports, as a multiple-antenna transmission scheme, at least one of Spatial Frequency Block Coding (SFBC), Spatial Time Block Coding (STBC), and Spatial Multiplexing (SM).

11. The method according to claim 10, wherein, when the transmit antenna supports SFBC, the pilot symbols are located adjacent to each other in a frequency domain, and wherein, when the transmit antenna supports STBC, the pilot symbols are located adjacent to each other in a time domain.

12. The method according to claim 1, wherein the pilot symbols include pilot symbols of two or more antennas, and a first antenna and a second antenna among the two or more antennas are multiplexed using different codes.

13. The method according to claim 1, wherein, when a first user and a second user perform collaborative transmission, the pilot symbols are multiplexed using different codes for the first and second users.

14. *315The method according to claim 13, wherein, when the first and second users each have one or more antennas, the first and second users are discriminated using different codes.

15. The method according to claim 1, wherein, when a first user and a second user perform collaborative transmission using the resource block, the pilot symbols are multiplexed using different antenna indices for the first and second users.

16. The method according to claim 1, wherein, when a first user and a second user perform collaborative transmission using the resource block, the pilot symbols are multiplexed using both different antenna indices for the first and second users and a code for the first and second users.
